(19) United States
(12) Patent Application Publication
(10) Pub. No.: US 2026/0075684 A1
(43) Pub. Date: Mar. 12, 2026

(54) CONTROLLING POWER DELIVERY TO A COOKING VESSEL SYSTEM AND METHOD

(71) Applicant: Channing Street Copper Company, Berkeley, CA (US)

(72) Inventors: Samuel Eli Calisch, Oakland, CA (US); Pushan Chandra Panda, San Francisco, CA (US); Mitchell Heinrich, Oakland, CA (US); Amelia Cosgrove Thomas, Belmont, CA (US)

(21) Appl. No.: 19/324,681

(22) Filed: Sep. 10, 2025

Related U.S. Application Data
(60) Provisional application No. 63/694,081, filed on Sep. 12, 2024.

(51) Int. Cl. H05B 6/12; H01F 27/28; H05B 6/06

(52) U.S. Cl. CPC H05B 6/1272; H01F 27/2885; H05B 6/062; H05B 2213/06; H05B 2213/07

(57) ABSTRACT

An objective of the present disclosure is to provide an energy storage device which can be stably operated during a power outage. According to one embodiment of the present disclosure, the energy storage device comprises: a battery connected to a solar panel and system power, and storing electric energy received from the solar panel or the system power in a direct current form or outputting stored electric energy to one or more loads; a system relay capable of connecting or blocking a power path connected to the system power; and a load relay capable of connecting or blocking a power path connected to the loads. When an abnormality occurs in the system power, the system relay is shut off to supply electric energy produced by the solar panel or stored in the battery to a preset load. The load relay is shut off when the charging amount of the battery becomes lower than an off reference value.

### CROSS-REFERENCE TO RELATED APPLICATIONS

This application is a non-provisional of and claims the benefit of U.S. Provisional Application No. 63/694,081, filed Sep. 12, 2024, entitled “CONTROLLING POWER DELIVERY TO A COOKING VESSEL SYSTEM AND METHOD,” with attorney docket number 0122186-006PR0. This application is hereby incorporated herein by reference in its entirety and for all purposes.

This application is also related to U.S. patent application Ser. No. 17/692,714, filed Mar. 11, 2022, entitled “APPLIANCE LEVEL BATTERY-BASED ENERGY STORAGE,” with attorney docket number 0122186-001US0, which is incorporated herein by reference.

This application is also related to U.S. patent application Ser. No. 18/814,022, filed Aug. 23, 2024, and entitled “BATTERY-INTEGRATED APPLIANCE SYSTEM AND METHOD” with attorney docket number 0122186-002US0, which is incorporated herein by reference.

### BACKGROUND

The field of cooking appliances has seen substantial innovation in recent years, particularly with the proliferation of induction cooktops. Induction heating provides efficient, precise, and rapid heating by generating electromagnetic fields to induce currents directly in the cooking vessel. However, controlling the heat applied to a cooking vessel via induction remains a challenge due to the lack of direct temperature feedback and the complex interaction between the induction coil and the vessel. Conventional systems often rely on temperature sensors located beneath the glass surface of the stove, leading to inaccurate or delayed readings and insufficient control over cooking temperatures.

Efforts to enhance temperature control in induction cooking systems have typically required extensive redesign of the stove hardware. This can include embedding sensors within the cooktop, modifying control software, and undergoing expensive and time-consuming safety certifications. Additionally, these systems are often stove-specific and lack portability or adaptability to different cooking setups. Attempts to retrofit existing stoves with precision heating or smart control features are hampered by the lack of interoperability and the limitations of conventional induction designs.

Moreover, traditional induction stoves offer limited feedback or programmability, making it difficult for users to achieve precise thermal profiles needed for complex or sensitive cooking tasks. There is an increasing demand for cooking systems that can intelligently and autonomously manage power delivery to the vessel, optimize heating based on temperature feedback, and offer features such as programmable recipes, safety interlocks, and modular adaptability without altering the base stove hardware.

In view of the foregoing, a need exists for an improved cooking vessel control system and method for managing power delivery in induction-based cooking environments in an effort to overcome the aforementioned obstacles and deficiencies of conventional systems.

### BRIEF DESCRIPTION OF THE DRAWINGS

FIG. 1 is an exemplary system diagram illustrating a power delivery network including a shield coil assembly, an induction stove, a user device and a stove server in accordance with an embodiment.

FIG. 2 is an exemplary exploded view illustrating a cooking vessel and a shield coil assembly including a shield coil and control circuitry in accordance with an embodiment.

FIG. 3 is an exemplary block diagram illustrating components of a shield coil assembly including a microcontroller, control circuitry, and switching element in accordance with an embodiment.

FIG. 4 is an exemplary system diagram illustrating a power delivery network with a cooking vessel, a shield coil assembly, and an induction stove in accordance with an embodiment.

FIG. 5a is an exemplary schematic diagram illustrating the shield coil in a transparent state in accordance with an embodiment.

FIG. 5b is an exemplary schematic diagram illustrating the shield coil in a shielded state in accordance with an embodiment.

FIG. 6 is an exemplary flow chart illustrating a method of switching between transparent and shielded modes of a shield coil assembly in accordance with an embodiment.

FIG. 7 is an exemplary circuit diagram illustrating a solid-state relay architecture for switching shield coil states and harvesting energy in accordance with an embodiment.

FIG. 8 is an exemplary circuit diagram illustrating a transformer-based architecture for switching shield coil states and powering components of the shield coil assembly in accordance with an embodiment.

FIG. 9 is an exemplary perspective view illustrating a shield coil assembly comprising a printed circuit board in accordance with an embodiment.

FIG. 10 is an exemplary perspective view illustrating a shield coil assembly comprising a flexible printed circuit board in accordance with an embodiment.

FIG. 11 is an exemplary side view illustrating the profile of a shield coil assembly comprising a flexible printed circuit board in accordance with an embodiment.

FIG. 12 is an exemplary diagram illustrating a stove system with a battery-integrated load source and power receptacle in accordance with an embodiment.

FIG. 13 is an exemplary block diagram illustrating components of a load source system including a battery, processor, memory, and communication modules in accordance with an embodiment.

FIG. 14 is an exemplary system diagram illustrating a battery-powered load source system for a stove including an auxiliary electrical output in accordance with an embodiment.

FIG. 15 is an exemplary circuit diagram illustrating an AC/DC conversion module with relay and charger connections, in accordance with an embodiment.

FIG. 16 is an exemplary system diagram illustrating multiple safety systems and switch circuits for a stove with a battery-powered load source in accordance with an embodiment.

FIG. 17 is an exemplary system diagram illustrating a relay system configured for oven and battery safety cut-offs in a stove system in accordance with an embodiment.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

Disclosed herein are example embodiments of a system and method of controlling power delivery to a cooking vessel on an induction stove that is independent of the induction driver of the induction stove. In various embodiments, this can allow the control to be situated in the pan, rather than in the stove. In some examples, this can result in simpler implementations, more portable implementations, and more accurate sensing and control (e.g., maintaining a given temperature in a pan).

Some embodiments can comprise, consist of, or consist essentially of a cooking vessel, a shielding coil, and control circuitry (e.g., including temperature sensing). In various embodiments, control circuitry can place the shield coil in an open circuit configuration, which can be called a “transparent” state. The control circuitry in some examples can put the shield coil in a short circuit configuration, which can be called a “shielded” state. When in the transparent state, in various embodiments the induction stove can heat the cooking vessel as if the shield coil is not present. When in the shielded state, in various examples the cooking vessel can be electromagnetically isolated from the induction stove. In some such cases, the induction stove can quickly detect the change and assume that no cookware is present. Induction stoves of various embodiments cut power to the driving circuitry when no pan is detected. Thus, when in the shielded state, in some examples current only flows in the shield coil for a short period of time until the stove determines that no cooking vessel is present and cuts power to the driving circuit of the burner. Because of this, the components of various embodiments don't need to be rated for continuous duty.

In some embodiments, the shield coil can double as a wireless transformer together with the coil in the induction stove. This can mean that in some examples, energy can be harvested to power the operations of the control circuitry. This power in various embodiments can be stored in a small onboard battery, capacitor, or the like. Such power can be used in some examples to sense the temperature of the cooking vessel and control the state of the shield coil. The shield coil in various examples can be operated using any suitable form of switching element, including a relay, a solid-state transistor, or the like.

In some embodiments, the control circuitry can comprise, consist of, or consist essentially of a simple thermal switch (e.g., a passive bimetallic temperature-controlled contact). In some examples, the control circuitry can comprise, consist of or consist essentially of a thermistor, a microcontroller with analog-to-digital converter, and a MOSFET switching element.

Various embodiments can be useful because temperature control of an induction stove can be a desirable feature can be difficult to implement in some examples because thermal sensing elements under a glass cooktop are not in intimate contact with the cooking vessel. This can mean that in some examples there is a time lag and temperature offset between the temperature of the vessel and the sensed value. Further, for induction systems of some examples, it is not easy to add temperature control functionality without significant effort (including redesign, re-testing, recertification of the hardware, and the like). Various embodiments can be configured to add temperature control without requiring these efforts by operating within the existing specification of the induction generator.

In some embodiments, multiple shield coils can be used to heat parts of a cooking vessel differentially. This can be used to alleviate hot spots in a pan in some examples, generate hot spots or areas, or the like.

In one instantiation, a system of the present disclosure can be used to implement an automatic kettle that can be used on various inductive stovetops. For example, a user can set the kettle to boil and in some embodiments the kettle can automatically turn off at a set temperature without further user intervention.

In another instantiation, a system of the present disclosure can be used to implement arbitrary temperature control in a cooking vessel. For example, in some embodiments a set point temperature can be set by a user and a control loop can run on the device to maintain that set point in the vessel by alternating between shielded and transparent configurations with a certain duty cycle. Such a vessel in various embodiments can implement a time-varying temperature, for instance to cook a given recipe automatically (e.g., cook on high heat for 5 minutes, then reduce to simmer for 20 minutes).

In some instantiations, a system of the present disclosure can be built into a cooking vessel as an integral component. In some instantiations, the shield coil and control circuitry can be a separate unit, or a modular unit configured to couple with various cooking vessels. In this way, any suitably sized cooking vessel could be used in conjunction with a heating system.

Some embodiments can include one or more of the following: pans that are tuned for specific temperatures, (e.g., a pan that is the perfect temperature for cooking delicate foods like fish, pots that are tuned to temper chocolate); stock pots that never boil over; a kettle with adjustable temperature settings for different teas and coffees; a pan with adjustable temperature settings and monitoring to ensure food safety; a mug or carafe that keeps your coffee warm, but not boiling; “smart trivets” to enable precision cooking (e.g., allowing recipes to call for 350° F. instead of “medium high” heat); a safety shield for children to keep temperatures from getting dangerous; an auto cutoff after a certain period of time, temperature or combination thereof (e.g., for the elderly or impaired); an intermediary device that harvests energy from the coil and just displays pan temperature; a switching mechanism that is not temperature based, but utilizes alternate sensors such as pressure for pressure cooking, or water vapor sensing for boiling at high altitudes; and the like.

Some embodiments can include lights or sounds to signal to the user that a set point has been reached. Some embodiments can include an alert via an app to signal to the user that a set point has been reached. In some instantiations, a temperature sensor is inside the cooking vessel, allowing for low latency in temperature feedback. In some instantiations, an auxiliary temperature sensor (e.g., wired or wireless) can be inserted into food being cooked for precise control of the temperature in the food being cooked. In some instantiations, data from the temperature sensor can be saved or transmitted to a database. In some instantiations, a previously or independently recorded temperature profile can be loaded from a database and played back on the device.

Some embodiments can include a piece of cookware or trivet that spans more than one induction coil on an induction cooktop and can independently control heat delivery from each of those coils to create either a homogenous cooking surface temperature (e.g., a pancake griddle) or a temperature gradient (e.g., to mimic a French top).

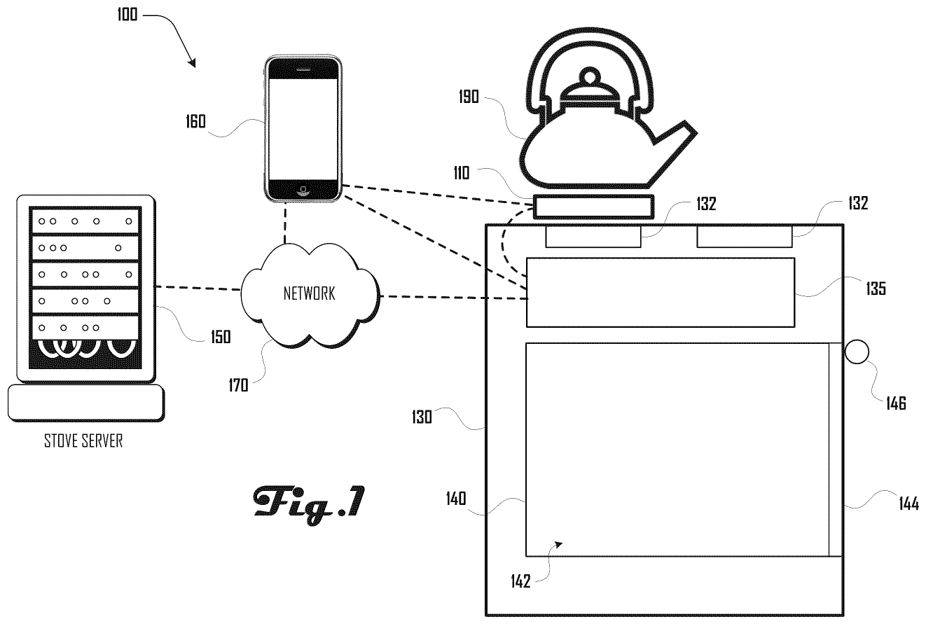

Turning to FIG. 1, an example embodiment of a power delivery network 100 is illustrated, which includes a shield coil assembly 110 and an inductive stove 130 that are operably connected to a stove server 150 via a network 170. A user device 160 is operably coupled to the stove server 150 via the network 170 and operably coupled to the shield coil assembly 110 and an inductive stove 130. As discussed in more detail herein, the power delivery network 100 can be configured to deliver power to a cooking vessel 190, which can result in heating of the cooking vessel 190.

As shown in this example, the stove 130 comprises a cooktop with a plurality of induction coil assemblies 132 that define induction cooking zones on the cooktop. The stove 130 further comprises a control system 135 and an oven assembly 140 that includes an oven cavity 142, and oven door 144 and a handle 146 that allows users to open and close the oven door 144 to expose the oven cavity 142.

As shown in this example embodiment, the shield coil assembly 110 can rest on one of the induction cooking zones over an induction coil assembly 132 with the cooking vessel 190 resting on the shield coil assembly 110. As discussed in more detail herein, the shield coil assembly 110 can be configured to selectively deliver power to the cooking vessel 190, which can cause heating of the cooking vessel 190 for cooking or other purposes.

In various embodiments, the shield coil assembly 110 and user device 160 can be operably coupled with the control system 135 of the stove 130 (e.g., via wired or wireless communication) such that there can be communication between shield coil assembly 110 and the control system 135 of the stove 130 and communication between the user device 160 and the control system 135 of the stove 130. In some embodiments, the shield coil assembly 110 and user device 160 can be operably coupled to the control system 135 of the stove 130 in various suitable ways, including Bluetooth, Wi-Fi, Near Field Communication (NFC), Zigbee, or the like.

The control system 135 of the stove 130 can be operably connected to the stove server 150 via the network 170, which can include one or more wired and/or wireless networks, such as a wide area network (WAN), a local area network (LAN), a personal area network (PAN), a metropolitan area network (MAN), a cellular data network (e.g., 4G, 5G, LTE), a satellite communication network, a virtual private network (VPN), a secure socket layer (SSL) or transport layer security (TLS) tunnel, a dedicated leased line, a fiber optic network, a cable broadband network, a digital subscriber line (DSL), a dial-up modem connection, a microwave communication link, a mesh network, a content delivery network (CDN) routing path, a peer-to-peer (P2P) overlay network, and the like. In various embodiments, the stove server 150 can include one or more of a cloud server, a web server, an application server, a database server, a file server, and the like.

In various embodiments, the user device 160 can be any suitable device, such as a smartphone, a tablet computer, a laptop computer, a desktop computer, a smartwatch, a smart ring, a smart speaker, a voice assistant device, an augmented reality (AR) headset, a virtual reality (VR) headset, a smart TV, a home automation hub, an e-reader, a handheld gaming console, a portable media player, a wearable fitness tracker, a smart home display panel, a wireless remote control, a programmable thermostat, and the like.

In various embodiments, the shield coil assembly 110 can be inoperable to communicate directly with the stove server 150 and can only communicate with the stove server 150 indirectly via the control system 135 of the stove 130. However, in some embodiments, the shield coil assembly 110 can be configured to communicate directly with the stove server 150 (e.g., via the network 170), so the example of FIG. 1 should not be construed to be limiting. Additionally, while some embodiments of a shield coil assembly 110 are configured for communication, some embodiments can be inoperable for communication with other devices such as a stove server 150, stove 130, or the like.

The user device 160 can be configured to communicate with the shield coil assembly 110, the stove 130 and the stove server 150 in some embodiments. However, in some embodiments, the user device may be inoperable to communicate with one or more of the shield coil assembly 110, the stove 130 and the stove server 150 in some embodiments. For example, in some embodiments the user device 160 can only communicate with the shield coil assembly 110 and stove server 150 indirectly via the stove 130.

The cooking vessel 190 can be any suitable type of cooking vessel, and while a kettle is shown as one example herein, further embodiments can include cast skillets, pots, Dutch ovens, woks, frying pans, saucepans, stockpots, sauté pans, pressure cookers, griddles, roasting pans, double boilers, grill pans, coffee percolators, steamers, multi-ply clad stainless cookware with magnetic cores, crepe pans, and the like. Also, while induction stoves for cooking are discussed in some examples, it should be clear that any suitable use of an induction stove or induction element is within the scope of the present disclosure. For example, cooking vessels 190 in some embodiments can include beakers, reaction vessels, crucibles, distillation flasks, evaporating dishes, autoclave containers, sample holders, test tube racks, fermentation tanks, mixing vessels, dyeing vats, melting pots, electroplating baths, medical sterilization trays, ink-mixing containers, nanoparticle synthesis vessels, pilot-scale reactors, pharmaceutical blending vessels, and the like.

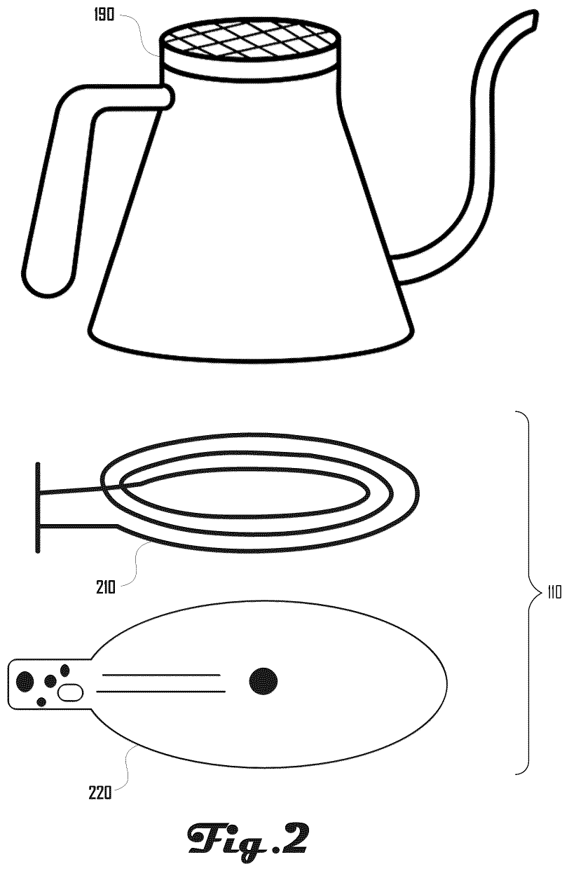

Turning to FIG. 2, an example of a cooking vessel 190 and a shield coil assembly 110 that includes a shield coil 210 and control circuitry 220 is illustrated. In various embodiments, the shield coil 210 can be configured to be positioned relative to an induction coil 132 of a stove 130 (see e.g., FIG. 1) to influence the magnetic field generated by the induction coil 132 of the stove 130. The shield coil 210 may be configured as a conductive loop or winding that is electrically coupled to ground or driven with a controlled current, such that the shield coil 210 operates to reduce, redirect, or otherwise shape electromagnetic fields produced by the induction coil 132 during operation.

The shield coil 210 may be arranged coaxially with the induction coil 132, offset laterally from the induction coil 132, integrated into a housing of the shield coil assembly 110 to define a boundary between the induction cooking zone and adjacent components of the shield coil assembly 110, or the like. In some embodiments, the shield coil 210 functions as an eddy current shield, where induced currents within the shield coil generate an opposing magnetic field that reduces electromagnetic interference with electronic circuits, sensors, or user interface components of the shield coil assembly 110.

In various embodiments, the shield coil 210 can be selectively energized as discussed herein to dynamically control coupling efficiency between the induction coil 132 of the stove 130 and a vessel 190 placed on the shield coil assembly 110. For example, the shield coil 210 may reduce coupling outside a central cooking region, thereby defining a more precise effective cooking zone or preventing unwanted heating of nearby metallic structures. In some embodiments, the shield coil 210 can allow for selective heating of the vessel 190 as discussed in more detail herein (e.g., by making the cooking vessel “shielded” or “transparent”).

The shield coil 210 may be fabricated from various suitable materials, including copper, aluminum, or another conductive material, and may include multiple turns arranged in a spiral, concentric ring, or mesh configuration. The geometry, spacing, and electrical properties of the shield coil 210 may be selected to provide a desired shielding effect over the frequency range of the induction coil 132 of the stove 130 (e.g., 20-60 kHz, or the like).

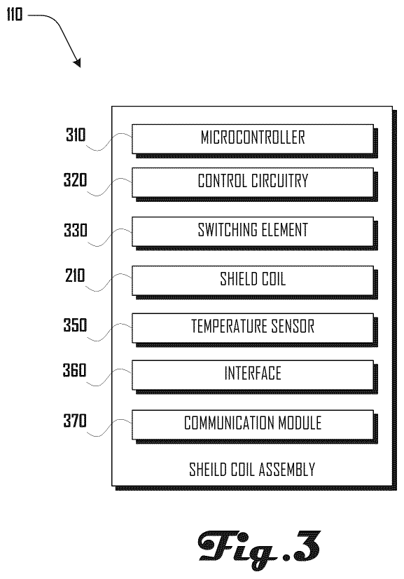

Turning to FIG. 3, a block diagram of an example shield coil assembly 110 is illustrated, which comprises a microcontroller 310, control circuitry 320, a switching element 330, a shield coil 210, a temperature sensor 350, an interface 1284 and a communication module 370.

In various embodiments, the microcontroller 310 can be configured to execute program instructions for controlling one or more operations of the shield coil assembly 110 based on instructions stored in a memory executed by a processor. The microcontroller in various examples can include a processor core, memory (e.g., volatile and/or non-volatile), and peripheral interfaces such as analog-to-digital converters, digital input/output ports, communication interfaces (e.g., I²C, SPI, UART, USB), and timers. In some embodiments, control functionality may be provided by any other suitable processing elements, such as a microprocessor, a digital signal processor (DSP), a system-on-chip (SoC), a field-programmable gate array (FPGA), or application-specific integrated circuitry (ASIC), or the like. Accordingly, reference herein to a “microcontroller” should not be construed to be limiting on the wide variety of systems that are within the scope and spirit of the present disclosure.

In some embodiments, control circuitry 320 can be configured to coordinate electrical and functional operations of the shield coil assembly 110. The control circuitry 320 may include driver circuits, power regulation circuits, signal conditioning circuits, and the like. For example, the control circuitry 320 may include gate drivers for switching power transistors coupled to the shield coil 210, voltage regulators for supplying stable power to electronic subsystems, amplifiers or filters for processing sensor signals, and the like. In various embodiments, the control circuitry 320 may operate in conjunction with, but separately from, a microcontroller or other processing element that executes higher-level control algorithms.

The switching element 330 in various embodiments can include various suitable elements including for example a relay, a solid-state transistor, a Metal-Oxide-Semiconductor Field-Effect Transistor (MOSFET) switching element, a bipolar junction transistor (BJT), an insulated-gate bipolar transistor (IGBT), a thyristor, a silicon-controlled rectifier (SCR), a triac, a gate turn-off thyristor (GTO), a phototransistor, an optocoupler-based switch, a junction field-effect transistor (JFET), a depletion-mode MOSFET, a p-channel or n-channel MOSFET, a GaN transistor, a SiC transistor, a microelectromechanical systems (MEMS) switch, a reed switch, a vacuum tube switch, and the like.

In various embodiments, the temperature sensor 350 can include a thermocouple, a resistance temperature detector (RTD), a thermistor, an infrared (IR) temperature sensor, a semiconductor temperature sensor, a diode-based temperature sensor, a platinum resistance thermometer (PRT), a digital temperature sensor (e.g., I²C or SPI interface), a fiber optic temperature sensor, a liquid crystal temperature sensor, a bimetallic temperature sensor, a pyroelectric sensor, a thermal imaging sensor, a surface acoustic wave (SAW) temperature sensor, a calorimetric flow temperature sensor, and the like.

In some embodiments, the interface 1284 can include one or more of a push-button, a capacitive touch button, a resistive touch button, a rotary knob, a dial, a slider control, a toggle switch, a rocker switch, a membrane keypad, a touchscreen, a voice input microphone, an LED indicator light, a multicolor RGB LED, a seven-segment display, an alphanumeric LCD display, an OLED display, an e-ink display, a graphical touchscreen display, a buzzer, a piezoelectric sounder, a vibration motor for haptic feedback, a speaker for audio output, a status bar with indicator lights, a progress bar display, and the like.

In some embodiments, the communication module 370 can include a Bluetooth module, a Wi-Fi module, a Zigbee module, a Z-Wave module, a Near Field Communication (NFC) module, a Radio Frequency Identification (RFID) module, a cellular communication module (e.g., 4G, LTE, 5G), a LoRa module, a Sigfox module, an Ultra-Wideband (UWB) module, a wired Ethernet module, a Power Line Communication (PLC) module, a USB communication module, a serial communication module (e.g., UART), an I²C communication module, an SPI communication module, a Controller Area Network (CAN bus) module, a satellite communication module, an infrared (IR) transceiver module, and the like. As discussed herein, the communication module 370 can provide for communication with a stove 130, a stove server 150, or the like.

While some example embodiments of a shield coil assembly 110 is illustrated in FIG. 3, it should be clear that further embodiments can have more or fewer elements, or can be more or less complex than the example of FIG. 3. For example, in some embodiments various elements can be specifically absent from the shield coil assembly 110 (e.g., the communication module 370). In various embodiments can comprise, consist of, or consist essentially of the various sets of the example components discussed herein. Accordingly, the example of FIG. 3 should not be construed to be limiting on the wide variety of additional embodiments of a shield coil assembly 110 that are within the scope and spirit of the present disclosure.

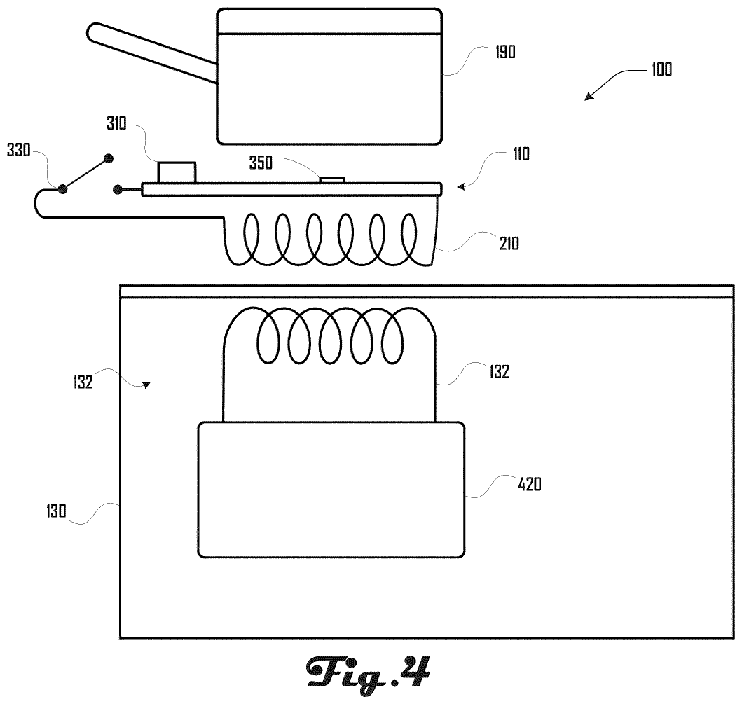

Turning to FIG. 4, an example embodiment of a power delivery network 100 is illustrated that includes a cooking vessel 190, a shield coil assembly 110 and a stove 130. In this example, the shield coil assembly 110 includes a microcontroller 310, a switching element 330, a shield coil 210, and a temperature sensor 350. The stove 130 includes an induction coil 410 and an induction driver 420.

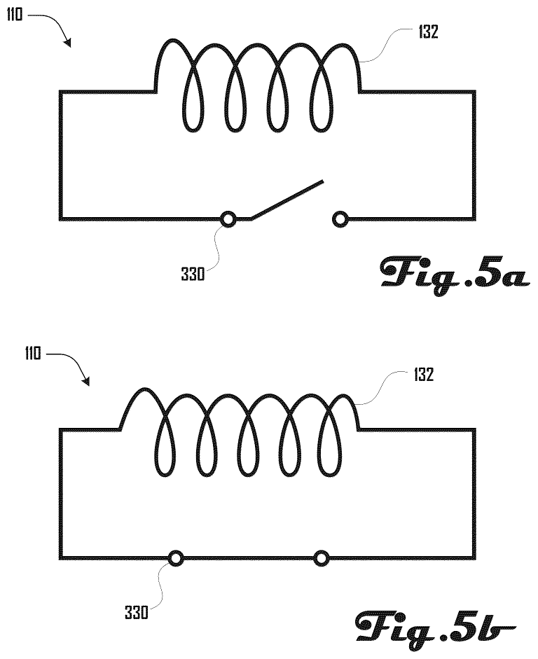

In various embodiments, the shield coil 210 can be put in an open circuit configuration, which can be called a “transparent” state in some examples (see e.g., FIGS. 4 and 5a). In various embodiments, the shield coil 210 can be put in a short circuit configuration, which can be called a “shielded” state (see e.g., FIG. 5b). When in the transparent state, in various embodiments the induction stove 130 can heat the cooking vessel 190 as if the shield coil assembly 110 is not present. When in the shielded state, in various examples the cooking vessel 190 can be electromagnetically isolated from the induction coil 132 and induction stove 130.

In various embodiments, when the shield coil 210 is placed in the open circuit configuration, the shield coil 210 is electrically floating and does not substantially generate counteracting eddy currents in response to the electromagnetic field generated by the induction coil 132. In this transparent state, the alternating magnetic field produced by the induction coil 132 couples directly into the cooking vessel 190, thereby inducing currents in the cooking vessel 190 and causing resistive heating in the normal manner. From the perspective of the induction stove 130, the shield coil assembly 110 may appear substantially absent or electromagnetically transparent.

When the shield coil 210 is placed in the short circuit configuration, the shield coil 210 forms a closed conductive loop such that eddy currents are induced within the shield coil 210 in response to the magnetic field from the induction coil 132. These induced currents in the shield coil 210 can generate an opposing magnetic field which can effectively cancel or redirect the electromagnetic flux that would otherwise couple into the cooking vessel 190. In this shielded state, the cooking vessel 190 is substantially electromagnetically isolated from the induction coil 132 of the stove 130, thereby preventing or significantly reducing heating of the cooking vessel 190.

In some such cases, the induction stove 130 can quickly detect a change between the transparent configuration and the shielded configuration and determine that a cooking vessel 190 is not present on the stove 130 over the induction coil 130, even though the cooking vessel 190 is still sitting on top of the shield coil assembly 110. An induction stove 130 of various embodiments can be configured to cut power to the induction coil 132 when no cooking vessel 190 is detected, even though the cooking vessel 190 is still sitting on top of the shield coil assembly 110. Thus, when in the shielded state, in various examples, current only flows in the shield coil 210 for a short period of time until the induction stove 130 determines that no cooking vessel 190 is present, (even though the cooking vessel 190 is still sitting on top of the shield coil assembly 110) and cuts power to the induction driver 420, which cuts power to the induction coil 132. Because of this, the components of a shield coil assembly 110 of various embodiments don't need to be rated for continuous duty.

In some embodiments, the shield coil 210 can double as a wireless transformer together with the induction coil 132 of the induction stove 130. This can mean that in some examples, energy can be harvested to power the operations of the shield coil assembly 110 (e.g., the microprocessor 310, control circuitry 320, switching element 330, temperature sensor 350, interface 1284, communication module 370, and the like). Accordingly, in some embodiments a battery can be absent from the shield coil assembly 110, a battery of the shield coil assembly 110 can be charged by via an induction coil 132 of an induction stove 130, a capacitor of the shield coil assembly 110 can be charged by via an induction coil 132 of an induction stove 130, and the like.

In various embodiments, such power can be used in some examples to sense the temperature of the cooking vessel 190 and control the state of the shield coil 210. For example, in some examples, the shield coil assembly 110 can selectively toggle the shield coil 210 between these transparent and shielded states based at least in part on sensed temperature and depending on the desired mode of operation. For example, the shield coil 210 may be placed in the transparent state to allow heating of the cooking vessel 190, and switched to the shielded state to interrupt heating to the cooking vessel 190, to provide safety interlock functionality, or to dynamically shape a heating zone presented to the cooking vessel 190.

Various embodiments can be useful because temperature control of an induction stove 130 can be a desirable feature that can be difficult to implement in some examples because thermal sensing elements under a glass cooktop of an induction stove 130 are not in intimate or direct contact with the cooking vessel 190. This can mean that in some examples there is a time lag and temperature offset between the temperature of the cooking vessel 190 and the sensed value, which may be undesirable and not allow for accurate heating and control of heating. Further, for induction systems of some examples, it is not easy to add temperature control functionality without significant effort (e.g., redesign, re-testing, recertification of the hardware, and the like). Various embodiments of shield coil assembly 110 can be configured to add desirable temperature control to an induction stove 130 without requiring such efforts by operating within the existing specification of the induction generator of the induction stove 130.

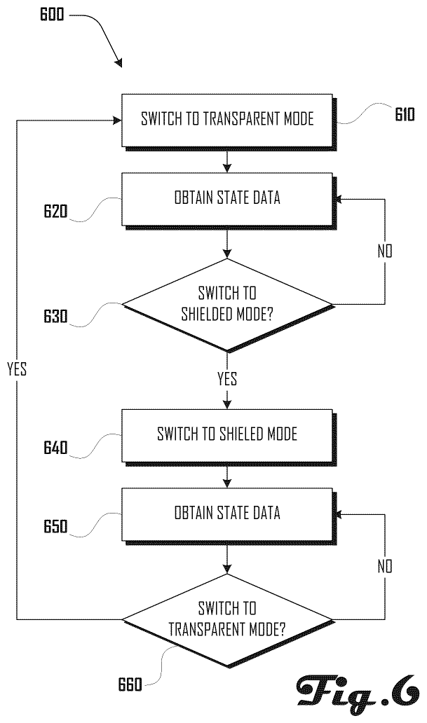

Turning to FIG. 6, a method 600 of determining and switching states of a shield coil assembly 110 is illustrated, which includes at 610, the shield coil assembly 110 switching to a transparent mode, and at 620, obtaining state data. For example, state data can include temperature data (e.g., obtained from temperature sensor 350) time data, power consumption data, current draw data, voltage level data, user input data, proximity sensor data, weight sensor data, motion sensor data, pressure sensor data, humidity data, airflow data, gas concentration data, optical sensor data, infrared sensor data, magnetic field data, acoustic sensor data, vibration data, position or orientation data, network-received control data, preset program data, error or fault detection data, and the like.

Accordingly, in various embodiments the shield coil assembly 110 can include various suitable sensors, such as one or more of thermocouple, a resistance temperature detector (RTD), a thermistor, a semiconductor temperature sensor, a real-time clock (RTC) module, a wattmeter sensor, a current shunt sensor, a Hall effect current sensor, a voltage divider sensor, a capacitive touch sensor, a mechanical push-button switch, a rotary encoder, an ultrasonic proximity sensor, an infrared proximity sensor, a load cell, a piezoelectric weight sensor, a passive infrared (PIR) motion sensor, an accelerometer, a gyroscope, a barometric pressure sensor, a capacitive pressure sensor, a digital humidity sensor, a hot-wire airflow sensor, a MEMS airflow sensor, a gas sensor (e.g., CO₂ sensor, CO sensor, methane sensor), a photodiode, a phototransistor, a CMOS optical sensor, an infrared thermopile sensor, a magnetometer, a reed switch, a Hall effect position sensor, a microphone, an ultrasonic sensor, a piezoelectric vibration sensor, an inertial measurement unit (IMU), a wireless network interface module, a Bluetooth beacon receiver, an error detection circuit (e.g., overcurrent protection sensor), a fault detection relay, a self-test diagnostic sensor, cooking vessel identity data, induction stove identity data, and the like.

Returning to the method 600, at 630, a determination is made whether or not to switch to a shielded mode based at least in part on the obtained state data, and if a determination is made to not switch to the shielded mode, the method 600 cycles back to 620 where state data is obtained. However, if a determination is made to switch to the shielded mode, the method continues to 640 where the shield coil assembly 110 switches to the shielded mode. At 650, state data is obtained, and at 660, a determination is made whether to switch the shield coil assembly 110 to the transparent mode. If a determination is made to not switch the shield coil assembly 110 to the transparent mode, then the method 600 cycles back to 650, where state data is obtained. However, if a determination is made to switch to the transparent mode, then the method 600 continues to 610 where the shield coil assembly 110 switches to the transparent mode. The method 600 in various embodiments can be performed based on instructions stored in a memory of the shield coil assembly 110 and executed by a process or of the shield coil assembly 110.

For example, in one embodiment, such a method 600 can be executed by a shield coil assembly 110 to heat a cooking vessel 190 on the shield coil assembly 110 to a defined temperature or temperature range and hold the cooking vessel 190 at the temperature or within the temperature range. For example, a temperature or temperature range can be set by a user and temperature data can be obtained (e.g., from a temperature sensor 350) that is indicative of a temperature of the cooking vessel 190. Where the temperature is below the defined temperature or temperature range, the shield coil assembly 110 can be maintained in or switched to the transparent mode such that power from the induction coil 132 of a stove 130 heats the cooking vessel 190. Temperature data can be obtained over time and the shield coil assembly 110 can be maintained in the transparent mode until obtained temperature data indicates that the temperature of the cooking vessel 190 has reached or exceeded the temperature or temperature range or is within a margin of error, and then the shield coil assembly 110 can then be switched to the shielded mode, which can stop heating of the cooking vessel 190.

For example, in one instantiation, a shield coil assembly 110 can be used to implement an automatic kettle that can be used on various inductive stovetops 130. For example, a user can set the kettle to boil, and in some embodiments, the kettle can automatically turn off or have heating removed at a set temperature automatically without further user intervention.

In various embodiments, the cooking vessel 190 can be held at the temperature or temperature range by continuing to monitor the temperature of the cooking vessel 190 via obtaining temperature data, and where the temperature falls below the temperature or temperature range or is within a margin of error thereof, then the shield coil assembly 110 can be switched to the transparent mode such that the induction coil 132 of the stove 130 heats the cooking vessel 190. The temperature of the cooking vessel 190 can be monitored continuously and switched between the shielded and transparent modes to maintain the cooking vessel at or within the temperature range or within a margin of error.

For example, in one instantiation, a shield coil assembly 110 can be used to implement arbitrary temperature control in a cooking vessel 190. For example, in some embodiments a set point temperature can be set by a user and a control loop can run on the shield coil assembly 110 to maintain that set point in the cooking vessel 190 by alternating between shielded and transparent configurations with a certain duty cycle.

In various embodiments, a cooking vessel 190 can be heated based on time data in addition to temperature data. For example, a cooking vessel 190 can be heated to a defined temperature or temperature range or within a margin of error thereof and can then be held at that temperature for a defined period of time until heading is turned off or until a new temperature or temperature range becomes the target. Accordingly, time data can be used, at least in part, to determine whether the shield coil assembly 110 should be put in a transparent mode or a shielded mode.

In one instantiation, a cooking vessel 190 or shield coil assembly 110 in various embodiments can implement a time-varying temperature; for instance, to cook a given recipe automatically (e.g., cook on high heat for 5 minutes, then reduce to simmer for 20 minutes).

In some embodiments, a shield coil assembly 110 of the present disclosure can be built into a cooking vessel as an integral component, the examples of the shield coil assembly 110 being a separate device should not be construed to be limiting. For example, in some embodiments, a shield coil assembly 110 can be disposed integrally within housing of a cooking vessel 190 or otherwise permanently coupled to or disposed within the cooking vessel 190 such that the shield coil assembly 110 is not easily removable from the cooking vessel (e.g., removal would be damaging or require tools or a substantial amount of work).

In some examples, the shield coil assembly 110 can be a separate unit from a cooking vessel, or a modular unit configured to couple with various cooking vessels 190. In this way, any suitably sized or configured cooking vessel 190 could be used in conjunction with a shield coil assembly 110 in some examples.

In some embodiments, a shield coil assembly 110 can comprise a plurality of shield coils 210, which can be used to heat parts of a cooking vessel 190 differentially. Some such embodiments can be used to alleviate hot spots in a pan in some examples, generate hot spots or areas, reduce or increase the amount of heat output, or the like. For example, some embodiments can include selectively making some of a plurality of shield coils 210 in a transparent mode, while making another portion of the shield coils 210 in a shielded mode. Having fewer shield coils 210 in a transparent mode instead of a shielded mode can result in less heat applied to the cooking vessel 190, which can reduce the rate of heating, which can be desirable in some examples for more controlled heating, such as when holding the cooking vessel 190 at a set temperature or temperature range. Less heat being applied to the cooking vessel 190 can result in more control and less temperature variance, which can be desirable for certain cooking applications. In contrast, having more shield coils 210 in a transparent mode instead of a shielded mode can result in more heat being applied to the cooking vessel 190, which can be desirable for heating the cooking vessel 190 up to a target temperature or range of temperatures quickly. This can be desirable in various cooking applications.

Accordingly, some embodiments can include determining a heating rate and selectively configuring a plurality of shield coils 210 of a shield coil assembly 110 to transparent mode or shielded mode. A plurality of shield coils 210 can be arranged in various suitable ways, such as a plurality of nested concentric rings, in a regular polygon shape based on the number of shield coils 210 present (e.g., triangle, square, pentagon, and the like).

Some embodiments can include one or more of the following: pans that are tuned for specific temperatures, (e.g., a pan that is the perfect temperature for cooking delicate foods like fish, pots that are tuned to temper chocolate); stock pots that never boil over; a kettle with adjustable temperature settings for different teas and coffees; a pan with adjustable temperature settings and monitoring to ensure food safety; a mug or carafe that keeps your coffee warm, but not boiling; “smart trivets” to enable precision cooking (e.g., allowing recipes to call for 350° F. instead of “medium high” heat); a safety shield for children to keep temperatures from getting dangerous; an auto cutoff after a certain period of time, temperature or combination thereof (e.g., for the elderly or impaired); an intermediary device that harvests energy from an inductive coil 132 of a stove 130 and just displays pan temperature; a switching mechanism that is not temperature based, but utilizes alternate sensors such as pressure for pressure cooking, or water vapor sensing for boiling at high altitudes; and the like.

In various embodiments, an interface 1284 of the shield coil assembly 110 and/or a user device 160 can be used to program or configure the shield coil assembly 110. For example, in some embodiments, a user can set one or more target temperature, one or more target temperature range, a time to hold a target temperature or temperature range before ceasing heating, a time to hold a target temperature or temperature range before switching to another target temperature or range, a target pressure or pressure range, a heating rate, a recipe, a cooking vessel type, a food type, a cooking type, an on or off command, and the like. Programming or configuration settings can of shield coil assembly 110 can be set via an interface 1284 of the shield coil assembly 110 and/or a user device 160 in various suitable ways, including by specifying a specific temperature or temperature range, specifying a margin of error for a specific temperature or temperature range, a heating mode (e.g., low, medium, high), and the like.

Some embodiments can include lights or sounds presented by an interface 1284 of the shield coil assembly 110 and/or a user device 160 to signal to the user that a set point has been reached. Some embodiments can include an alert via an app at the user device 160 to signal to the user that a set point has been reached. In some instantiations, a temperature sensor 350 can be inside, directly associated with or coupled to the cooking vessel 190, allowing for low latency in temperature feedback. In some instantiations, an auxiliary temperature sensor (e.g., wired or wireless) can be inserted into food being cooked for precise control of the temperature in the food being cooked. For example, temperature data can be sent to the shield coil assembly 110, a user device 160, the stove 130, or the like.

In various embodiments, data can be transmitted to and stored at the stove server 150 such as data from the shield coil assembly 110, stove 130, user device 160, and the like. Such data can be used in various ways, such as creating a cooking profile of a user, to determine how to control the shield coil assembly 110, stove 130, or the like. In some examples, the stove server 150 can be configured to control or configure the shield coil assembly 110 or stove 130, can be configured to update software or firmware of the shield coil assembly 110 or stove 130, or the like. In some instantiations, data from the temperature sensor 350 can be saved or transmitted to a database (e.g., the stove server 150). In some instantiations, a previously or independently recorded temperature profile can be loaded from a database and played back on the shield coil assembly 110, stove 130.

Some embodiments can include a shield coil assembly 110 (e.g., a piece of cookware or trivet) that spans more than one induction coil 132 on a cooktop of a stove 130. In various examples such a shield coil assembly 110 can be configured to independently control heat delivery from each of those induction coils 132 to create a homogenous cooking surface temperature (e.g., a pancake griddle), a temperature gradient (e.g., to mimic a French top), or the like. In various embodiments, such a shield coil assembly 110 can comprise a plurality of shield coils disposed in any suitable arrangement as discussed herein.

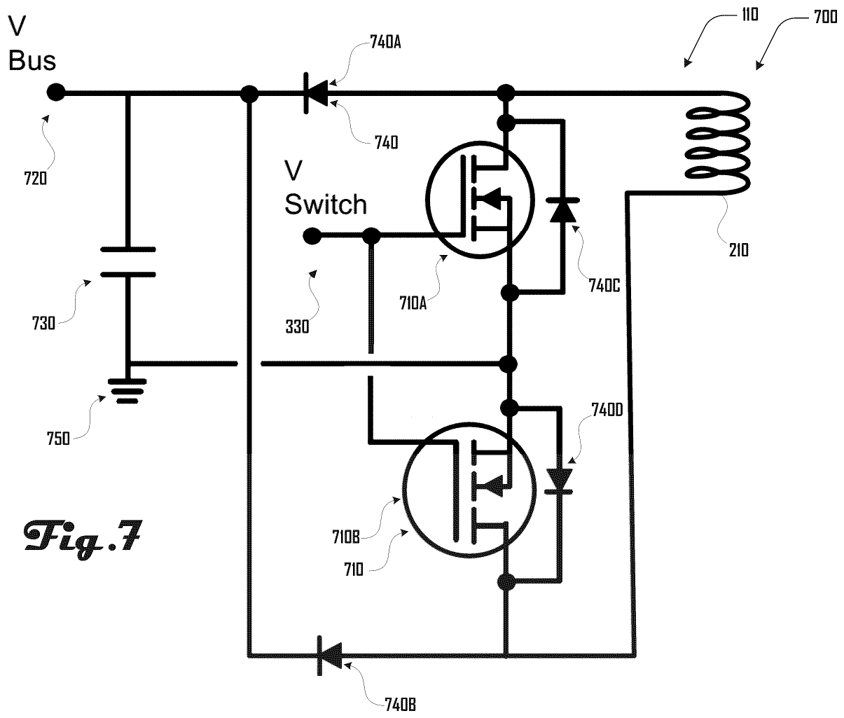

Turning to FIG. 7, an example embodiment of a solid-state relay architecture of a circuit 700 of shield coil assembly 110 is illustrated, which can be used to switch between transparent and shielded modes. For example, when the switch 330 is open (e.g., transparent mode), a plurality of diodes 740 can form a rectifier circuit which harvests power from the shield coil 330, supplied at a V_BUS 720.

In various embodiments, the circuit 700 of the shield coil assembly 110 can be configured to operate in conjunction with an induction stove 130 that includes one or more induction coils 132 configured to generate electromagnetic fields for heating a cooking vessel 190. The circuit of FIG. 7 can enable the shield coil 210 to be selectively placed in different electrical states so as to either permit heating of the cooking vessel 190 (e.g., transparent state) or inhibit heating of the cooking vessel 190 (e.g., shielded state).

The circuit 700 includes a voltage bus 720 (V Bus) that provides electrical power to the shield coil assembly 110, such as power harvested from the induction field of the induction stove 130. A capacitor 730 is coupled between the voltage bus 720 and a ground 750 to stabilize the bus voltage and provide transient energy storage. A switch input 330 (V Switch) can be used to control the operation of one or more MOSFETs 710.

A set of discrete diodes 740A-740D are provided in the circuit 700 to control current paths under different operating conditions. Diode 740A is positioned between a voltage bus 720 and the first MOSFET 710A, and diode 740B is positioned at a lower return node of the circuit 700.

Together, diodes 740A and 740B form part of a rectifier configuration that allows the circuit 700 to harvest power from the shield coil 210 when the MOSFETs 710 are in an open configuration (transparent state). Diodes 740C and 740D are coupled across the MOSFET switch nodes (i.e., across switch branches) to provide free-wheeling/clamping paths during switching transitions and to protect the MOSFETs 710 from voltage spikes generated by the inductive shield coil 210.

In operation, when the control input 330 drives the MOSFETs 710 into a non-conducting state, the shield coil 210 is effectively open-circuited. In this transparent state, the electromagnetic field generated by the induction coil 132 of the stove 130 couples directly into the cooking vessel 190, allowing the cooking vessel to be heated as if the shield coil assembly 110 were not present. During this mode, the induced current in the shield coil 210 is rectified through diodes 740A and 740B to provide a DC voltage on the voltage bus 720, which may be used to power control electronics of the shield coil assembly 110.

When the control input 330 drives the MOSFETs 710 into a conducting state, the shield coil 210 is placed into a low-resistance closed loop. In this shielded state, alternating currents are induced in the shield coil 210 that generate opposing magnetic fields. These opposing fields electromagnetically isolate the cooking vessel 190 from the induction coil 132 of the stove 130, thereby preventing or significantly reducing heating of the cooking vessel 190. In some embodiments, this shielding action may be used as a safety feature, a heating zone control function, or as part of a dynamic power management strategy as discussed in detail herein.

Accordingly, the circuit 700 of FIG. 7 in various embodiments can provide a dual functionality: (i) allowing harvested energy from the shield coil 210 to supply the voltage bus 720 in the transparent state, and (ii) providing selective electromagnetic shielding of the cooking vessel 190 in the shielded state.

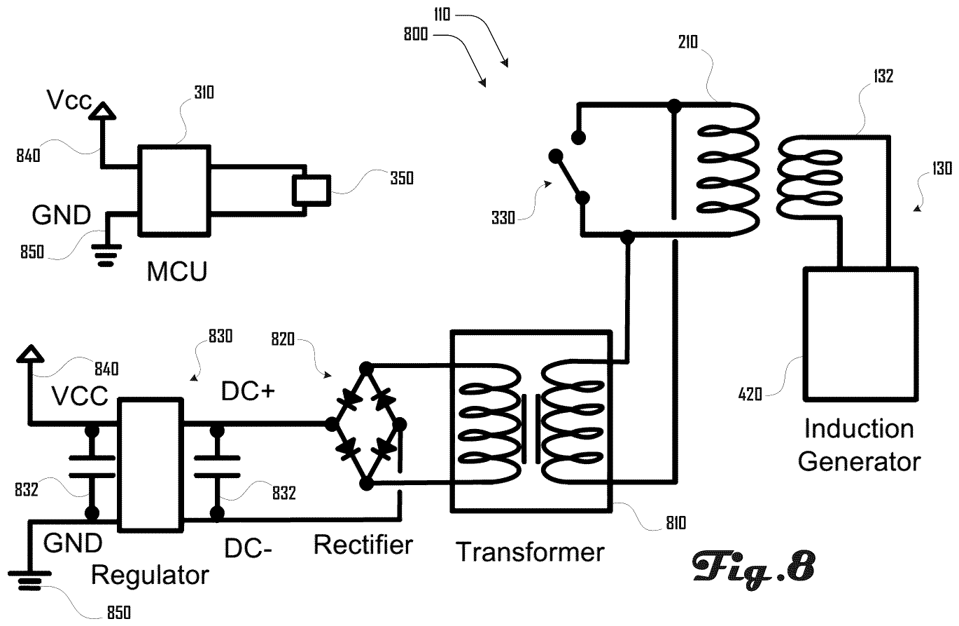

FIG. 8 is a circuit diagram of another example architecture of a circuit 800 of a shield coil assembly 110 that can be used in some embodiments to switch between transparent and shielded modes, while also harvesting the energy needed to run a microcontroller 310 and temperature sensor 350 and to selectively switch a shield coil 210 between a transparent state and a shielded state. In this example, the circuit 800 of the shield coil assembly 110 can be associated with an induction stove 130 that includes an induction generator 420 coupled to an induction coil 132, which generates a high-frequency alternating magnetic field during operation. The shield coil 210 of the shield coil assembly 110 can be positioned to couple with the induction coil 132 and, depending on its electrical configuration, may provide electromagnetic energy to couple into a cooking vessel 190 (e.g., a transparent mode) or generate opposing fields that inhibit coupling into the cooking vessel 190 (e.g., a shielded mode).

The circuit 800 includes a switching element 330 coupled in series with the shield coil 210. The switching element 330 may be controlled by a microcontroller (MCU) 310 to selectively place the shield coil 210 in an open-circuit or closed-circuit configuration. When the switching element 330 is in an open state, the shield coil 210 can be electrically isolated, thereby providing a transparent state in which the induction coil 132 heats a cooking vessel 190 as though the shield coil 210 were not present. When the switching element 330 is in a closed state, the shield coil 210 forms a conductive loop that induces circulating currents, which generate opposing electromagnetic fields that substantially shield the cooking vessel 190 from the induction coil 132, thereby reducing or preventing heating.

A temperature sensor 350 is electrically coupled to the MCU 310 and can be configured to monitor the temperature of the cooking vessel 190 as discussed herein. Based on data from the temperature sensor 350, the MCU 310 may change the state of the switching element 330 to generate the shielded and transparent states.

The circuit 800 further includes a power supply path that allows the shield coil 210 to act as an energy-harvesting element for powering the MCU 310 and the temperature sensor 350. In particular, a transformer 810 is connected in series with the shield coil 210 such that current induced in the shield coil 210 is supplied directly through a primary winding of the transformer 810. The transformer 810 in turn provides an alternating output voltage across its secondary winding suitable for rectification by a rectifier 820. The output of the transformer 810 is coupled to the rectifier 820, which may be implemented in various embodiments as a diode bridge configured to convert alternating current into a direct current voltage (DC+ and DC−).

The direct current output of the rectifier 820 can be supplied to a regulator 830, which conditions the rectified voltage into a stable supply voltage Vcc 840 and a ground 850 reference. The regulator 830 may operate in conjunction with associated input and output capacitors 832 that provide filtering and voltage stabilization. The regulated voltage Vcc 840 can provide power to the MCU 310, temperature sensor 350, and control circuitry associated with the switching element 330, thereby allowing the shield coil assembly 110 to be self-powered in some examples without requiring an external power source.

In operation, the circuit 800 in various embodiments provides both selective electromagnetic shielding of a cooking vessel by way of switching element 330 and shield coil 210, as well as energy harvesting through transformer 810, rectifier 820, and regulator 830 to supply power to the MCU 310 and temperature sensor 350. This configuration can allow the shield coil assembly 110 to operate autonomously in coordination with induction stove 130 without requiring external wiring or dedicated power connections.

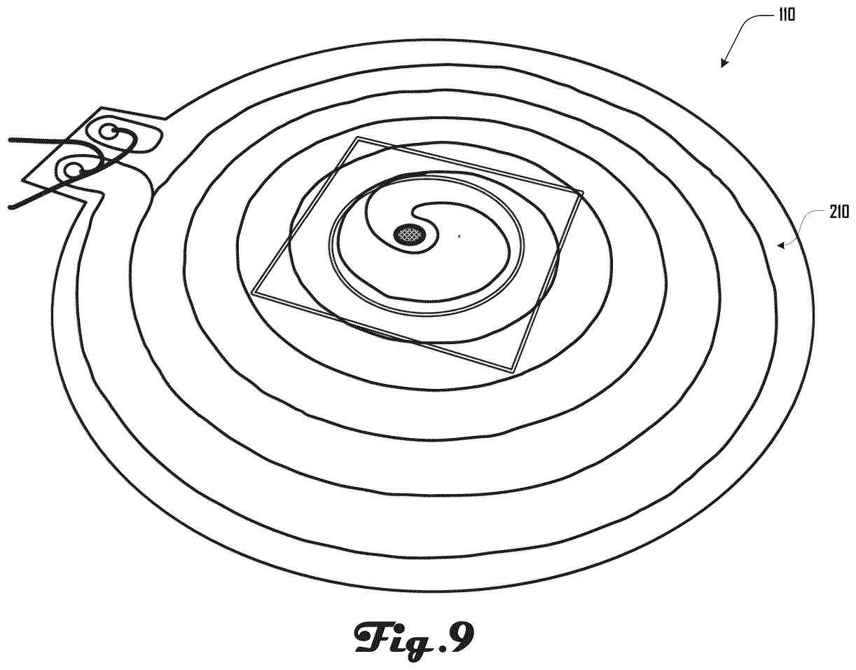

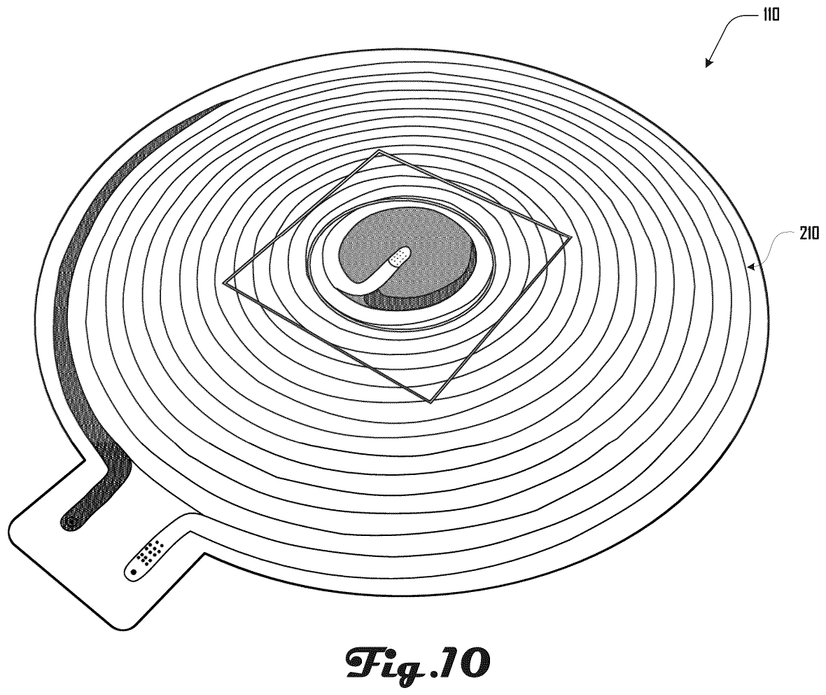

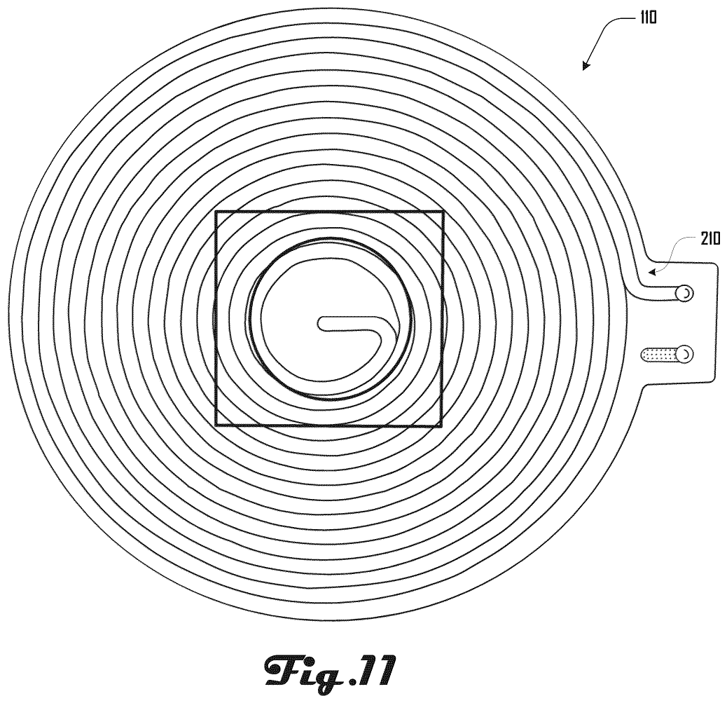

A shield coil assembly 110 can be embodied in a variety of different suitable form factors. For example, FIG. 9 is a perspective view of a shield coil assembly 110 where the shield coil assembly 110 comprises a printed circuit board. FIGS. 10 and 11 illustrate a shield coil assembly 110 where the shield coil assembly 110 comprises a flexible printed circuit board.

In some examples, a shield coil assembly 110 can have a planar circular body with a single tab extending from a side of the circular planar body coincident with the plane of the planar circular body. In various embodiments, a shield coil assembly 110 can have a thin profile such at least the planar circular body having a thickness of 0.1 cm, 0.2 cm, 0.3 cm, 0.4 cm, 0.5 cm, 0.6 cm, 0.7 cm, 0.8 cm, 0.9 cm, 1.0 cm, or the like, or a range between such example values. In various examples, a shield coil assembly 110 can have various suitable widths (e.g., the diameter of a planar circular body), such as 5.0 inches, 5.5 inches, 6.0 inches, 6.5 inches, 7.0 inches, 7.5 inches, 8.0 inches, 8.5 inches, 9.0 inches, 9.5 inches, 10.0 inches, 10.5 inches, 11.0 inches, 11.5 inches, 12.0 inches, or the like, or a range between such example values.

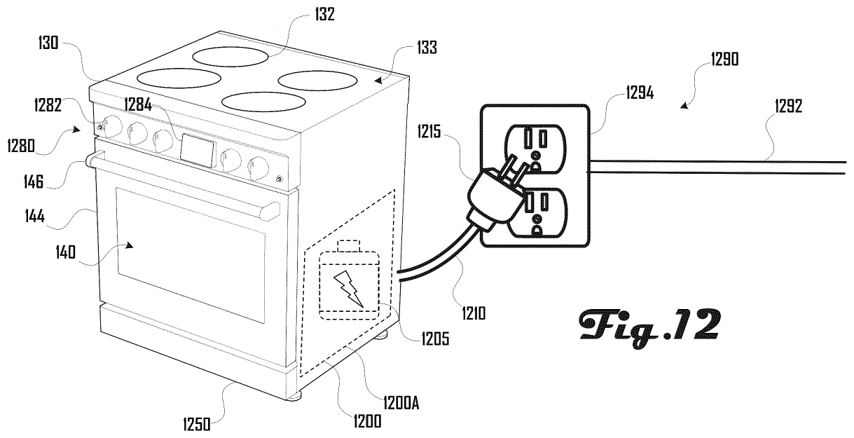

FIG. 12 illustrates an example of a stove 130 load source that comprises an embodiment 1200A of a load source system 1200 having a battery 1205. For example, the load source system 1200A can be an internal component of the stove 130, an integral component of the stove 130, disposed within a housing of the stove 130, or the like. For example, in some embodiments, a portion of the load source system 1200A and/or battery 1205 can be an integral part of the stove 130 such that such portions cannot be removed or easily removed from the stove 130, which can include, in some examples, such portions being enclosed within a housing of the stove 130 so that such portions are not accessible externally to users. However, in some examples, the battery 1205 can be removable, replaceable, and/or modular as discussed herein.

As shown in FIG. 12, the stove 130 can comprise a power cord 1210 with a plug 1215 configured to couple with an electrical power receptacle 1294 of a power distribution system 1290. For example, the power distribution system 1290 can provide power to the receptacle 1294 via power lines 1292, where the receptacle 1294 is disposed on a wall of a building with power lines 1292 running through the wall, or the like. The stove 130 can plug into the receptacle 1294 which can provide electrical power to the stove 130 and the battery 1205 of the load source system 1200, which can be configured to store electrical power and/or provide electrical power to the stove 130 as discussed herein.

In various embodiments, the stove 130 can comprise a housing 1250, an oven 140 having an oven door 144, a cooktop 144 having one or more heating regions 132 and a stove interface having a plurality of knobs 1282 and an interface 1284. As discussed herein in more detail such elements can be a part of or associated with the load source system 1200, such as heating elements of a load source system 1200 being configured to generate heat in the oven 140 and/or at the cooktop 144 based at least in part on configuration of the knobs 1282 and/or interface 1260. In various embodiments, the stove 130 can be an inductive stove that includes an induction driver 420 that powers induction coils 132 associated with one or more heating regions. However, the oven 140 and/or heating regions 132 of the cooktop 144 can be heated or generate heat in any suitable way in further embodiments, including inductive heating, resistive heating, gas heating, halogen heating, microwave heating, convection heating, radiant heating, steam heating, solid fuel heating, and the like.

One preferred embodiment includes a stove 130 that is standard 30-inch range having a width of 29⅞ inches; depth of 28 15/16 inches, including handle 146; and height of 35¾ to 36¼ inches to the cooking surface. Further embodiments of a stove can have a standardized or customized width of, or be configured for a width of, 20, 22, 24, 26, 28, 30, 32, 34, 36, 38, 40, 42, 44, 46, 28 inches, and the like, or a range between such example values. In some embodiments, a stove 130 can have a depth of 25, 26, 27, 28, 29, 30 inches, or the like, or a range between such example values. In various embodiments, a stove 130 can be configured for a standard 36-inch countertop height with adjustable legs that provide adjustment of +/−0.25, 0.5, 0.75, 1.0 inches, or the like, or a range between such example values.

In one preferred embodiment, a stove 130 has an oven 140 with an oven capacity of 4.55 cubic feet, and oven width of 22⅛ inches, an oven depth of 16¼ inches, an oven height of 17 inches and five oven rack positions. Further embodiments can include an oven 140 with a capacity of 2.0, 2.5, 3.0, 3.5, 4.0, 4.5, 5.5, 6.0, 6.5 cubic feet, or the like, or a range between such example values.

In one preferred embodiment, a cooktop 144 of a stove 130 comprises four symmetrical 7.9-inch high-power induction cooking zones 132 that have a minimum pan pairing size of 3⅛ inches. In further embodiments, a stove 130 can comprise any suitable number of cooking zones 132, including 1, 2, 3, 4, 5, 6, 8, 10, 12, or the like, or a range between such example values. Such cooking zones 132 can be the same size or different sizes and can include a diameter of 5, 6, 7, 8, 9, 10, 11, 12 inches, or the like, or a range between such example values. Such cooking zones 132 can be planar or in some embodiments can be concave to accommodate a curved pan (e.g., for induction cooking). However, it should be clear that further embodiments can include any suitable stove, range, or the like, which can include any suitable elements in various suitable configurations, so the present examples should not be construed as being limiting.

In some embodiments, one or more batteries 1205 and/or battery systems 1200 can be integrated into a load source (e.g., into an appliance housing) at the factory where the load source is manufactured or can be integrated into load source aftermarket. For example, load sources (e.g., appliances) can be specifically designed to allow integration of the appropriate quantity of batteries 1205 and/or other elements of a load source system 1200 within their normal housing. This can allow for such load sources or appliances to be placed within a residence without any change to how they are integrated into standardized fixturing, such as counters. In various embodiments, electrical connections to batteries 1205 and/or other elements of a load source system 1200 are made in the factory and fully integrated into the appliance circuit. This can allow for load sources such as appliances that utilize DC current (e.g., induction stove) to pull power directly from the one or more batteries 1205 without the added cost of a high-power inverter.

In some embodiments, batteries can be designed to be integrated into load sources (e.g., appliances) in an aftermarket factory setting. For example, a company that is not the original equipment manufacturer of an appliance buys new appliances, installs the load source system 1200 in their own facility, and re-sells the appliance as new. The retrofitter in some examples installs one or more batteries 1205 and/or elements of the load source system 1200 within the housing of the appliance, wiring them directly into the integral electrical system of the appliance. This can be desirable in some embodiments if high-voltage connections are required given the danger of such high-voltage connection if not being handled by a professional. Also, in some embodiments where a load source (e.g., an appliance) has an internal rectification circuit, such as an induction stove or the like, that is converting 60 Hz AC current to DC, it can be desirable in some examples to connect the load source system 1200 directly into the internal circuitry of the load source (e.g., to avoid costly addition of high-power inversion).

In some embodiments, batteries 1205 and elements of a load source system 1200 are designed to nest with load sources (e.g., appliances), either as a footing, or a backing, etc. Such nesting can be done by the customer in various examples. Batteries 1205 and/or elements of a load source system 1200 can be designed to nest directly external to the appliance, such as by taking into consideration the shape and intended location of the appliance within a house 105. One or more batteries 1205 and elements of a load source system 1200 (e.g., power control stage) are packaged in such a way in various examples such that they can be placed directly alongside the appliance. The appliance can be plugged into the load source system 1200 and the load source system 1200 is then plugged into the wall.

Additionally, it should be clear that a powered building system can include any suitable number and type of battery systems 1200 including one or more of the battery systems 1200 shown herein. However, in some examples one or more of the battery systems 1200 shown herein can be specifically absent.

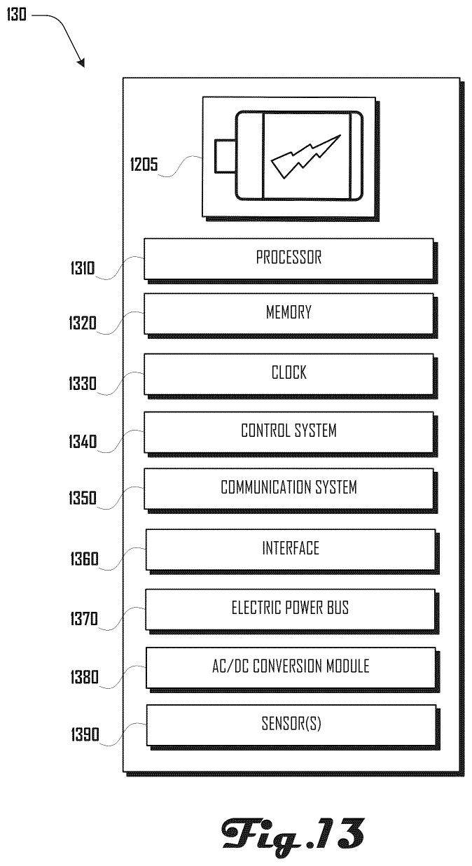

A load source system 1200 can comprise various suitable elements. For example, FIG. 13 illustrates one example embodiment of a load source system 1200, which can comprise one or more batteries 1205, a processor 1310, a memory 1320, a clock 1330, a control system 1340, a communication system 1350, an interface 1360, an electrical power bus 1370, an AC/DC conversion module 1380 and one or more sensors 1390.

For example, in some embodiments, a load source system 1200 can comprise a computing device which can be configured to perform methods or portions thereof discussed herein. The memory 1320 can comprise a computer-readable medium that stores instructions, that when executed by the processor 1310, causes the load source system 1200 to perform methods or portions thereof discussed herein, or other suitable functions. The clock 1330 can be configured to determine date and/or time (e.g., year, month, day of the week, day of the year, time, and the like) which as discussed in more detail herein, can in some examples be used to configure the power storage and/or power discharge of the battery 1205 based on time.

The control system 1340 in various embodiments can be configured to control power storage and/or power discharge of the battery 1205 based on instructions from the processor, or the like. Additionally, in some embodiments, the control system 1340 can determine various aspects, characteristics or states of the battery 1205 such as a charge state (e.g., percent charged or discharged), battery charge capacity, battery health, battery temperature, or the like. For example, in various embodiments, a load source system 1200 can comprise various suitable sensors to determine such aspects, characteristics or states of the battery 1205 or aspects, characteristics or states of other elements of a building system, which can include environmental conditions such as temperature, humidity, or the like, internal to or external to a building.

In some embodiments, the control system 1340 can be configured for various features such as: maintaining a data pipeline to the cloud or another wireless device (e.g., by way of CANBus communication between peripherals and a Wi-Fi, Bluetooth, or Cellular module) to remotely log system data and manage firmware updates; interpreting the states/positions of user interface controls (e.g., knobs, buttons, switches) and carrying out corresponding actions within the device; providing feedback control to cooking operations of the load source system 1200 via temperature and current sensing; and the like. The control system 1340 may additionally be used in enabling and facilitating various operating modes and features (e.g., cooking features, safety features, etc.)

In various embodiments, the communication system 1350 can be configured to allow the load source system 1200 to communicate via one or more communication networks 170 as discussed in more detail herein, which in some embodiments can include wireless and/or wired networks and can include communication with devices such as one or more other battery systems 1200, user device 160, server 150, or the like.

The interface 1360 can include various elements configured to receive input and/or present information (e.g., to a user). For example, in some embodiments, the interface can comprise a touch screen, a keyboard, one or more buttons, one or more knobs, one or more lights, a speaker, a microphone, a haptic interface, and the like. In various embodiments, the interface 1360 can be used by a user for various suitable purposes, such as to configure the load source system 1200, view an aspect, characteristic or state of the load source system 1200, configure network connections of the load source system 1200, or the like. In some embodiments, the interface 1360 can comprise a stove interface 1280 having a plurality of knobs 1282 as shown in the example of FIG. 12.

The electrical power bus 1370 can be configured to obtain electrical power from one or more sources and/or provide electrical power to one or more load sources. For example, in various embodiments, the electrical power bus 1370 can obtain power from one or more power receptacles 1294 (see, e.g., FIG. 12) or other suitable interface with a power distribution system 1290, or directly from a power source such as an electrical power grid 110, solar panel 115, or the like. Such obtained electrical power can be stored via one or more batteries 1205 or can be directed to one or more load sources connected to the load source system 1200. Such obtained electrical power can be directed to such one or more load sources via the one or more batteries 1205 or bypassing the one or more batteries 1205.

In various embodiments, the AC/DC conversion module 1380 (e.g., in an induction stove 130) can be configured for transforming the alternating current (AC) such as from a standard household outlet into direct current (DC) suitable for powering various elements of the load source system 1200 (e.g., parts of an induction stove). The AC/DC conversion module 1380 of various examples can include a rectifier circuit, which converts the AC voltage into a pulsating DC voltage, followed by a filter that smooths out the fluctuations to produce a steady DC output. Additionally, the AC/DC conversion module 1380 of various embodiments can include voltage regulation circuitry to ensure the output remains within a specific voltage range, accommodating the precise needs of the elements of the load source system 1200 such as electronic controls and induction driver. The AC/DC conversion module 1380 of some examples not only powers the main induction heating elements but also supplies DC power to auxiliary components such as a control panel, sensors, a cooling fan, and the like. Example embodiments of an AC/DC conversion module 1380 and components thereof are discussed in more detail herein.

Any suitable sensors 1390 can be used in a load source system 1200. For example, various suitable sensors can be used for sensing temperature (e.g., for generating an over-temperature cut-off response) can including thermal fuses, thermostats, thermocouples, thermistors, PTC (Positive Temperature Coefficient) devices, RTDs (Resistance Temperature Detectors), bimetallic switches, IC temperature sensors, thermal cut-out switches, infrared sensors, and the like.

In further embodiments, sensors can include one or more of magnetic field sensors, like Hall effect sensors, to detect the presence and size of cookware; current and voltage sensors to monitor power consumption and protect against fluctuations; capacitive touch sensors for a user interface; safety features that can be supported by overheating protection and boil-dry detection sensors; pan detection sensors to identify when cookware is placed on or removed from cooking zones; power monitoring sensors to manage power distribution; residual heat sensors to indicate when a cooktop 144 is still hot after use; electromagnetic interference sensors to monitor and minimize emissions; humidity sensors to detect steam and adjust cooking parameters; weight sensors for more precise cooking; and the like.

The one or more batteries 1205 can be any suitable system configured to store and discharge energy. For example, in some embodiments, the one or more batteries 1205 can comprise rechargeable lead-acid, nickel-cadmium (NiCd), nickel-metal hydride (NiMH), lithium-ion (Li-ion), LiFePO₄ (Lithium Iron Phosphate), lithium-ion polymer (LiPo), rechargeable alkaline batteries, Sodium-ion (Na-ion), Lithium Titanate (LTO), Lithium Sulfur (Li—S), Nickel-Zinc (Ni—Zn), Zinc-Air, Solid-state lithium, Flow batteries (e.g., Vanadium Redox Flow Batteries), or the like.

In some embodiments, a battery 1205 of a load source system 1200 can be configured to generate various suitable voltages, including 80V, 90V, 100V, 110V, 120V, 130V, 140V, 150V, 160V, 170V, 180V, 190V, 200V, 210V, 220V, 230V, 240V, 250V, 260V, and the like, or a range between such example values. A battery 1205 in various examples can comprise a plurality of cells, which in some examples can have a nominal voltage 3.0V, 3.1V, 3.2V, 3.3V, 3.4V, 3.5V. In one example, a battery 1205 can comprise 72 cells in series, which can generate a voltage of ˜240VDC (e.g., between 230VDC and 250VDC).

In various embodiments, components of the load source system 1200, such as heating regions 132 of the cooktop 144, oven 140, auxiliary electrical output 1440, and the like can be configured to operate at different input voltages such as 120V, 130V, 140V, 150V, 160V, 170V, 180V, 190V, 200V, 210V, 220V, 230V, 240V, 250V, 260V, and the like, or a range between such example values. For example, such an input voltage can be based on power from one or both of a receptacle 1294 (e.g., 120V receptacle) and battery 1205.

As discussed herein, rechargeable in various embodiments can be defined as having the ability to store and discharge energy multiple times without substantial degradation of the ability to store and discharge energy for at least a plurality of cycles (e.g., 5, 10, 50, 100, 500, 1000, 10 k, 100 k, 1M, 10M, 100M, or the like). While various preferred embodiments can include chemical storage of electrical energy, in further embodiments one or more batteries 1205 can be configured to store energy in various suitable ways, such as mechanical energy, compressed fluid, thermal energy, and the like.

In some embodiments, the one or more batteries 1205 can contain or be defined by removable cartridges that allow the one or more batteries 1205 to scale or be replaced. Battery packs in some examples can be composed of small sub-packs that can be easily removed. This can allow for old or faulty cells to be replaced in some examples. Additionally, in some examples such a configuration allows for the fine tuning of pack size within a network of load source systems 1200 as discussed herein. For example, one or more batteries 1205 can be initially sized and co-located with an expected load source.

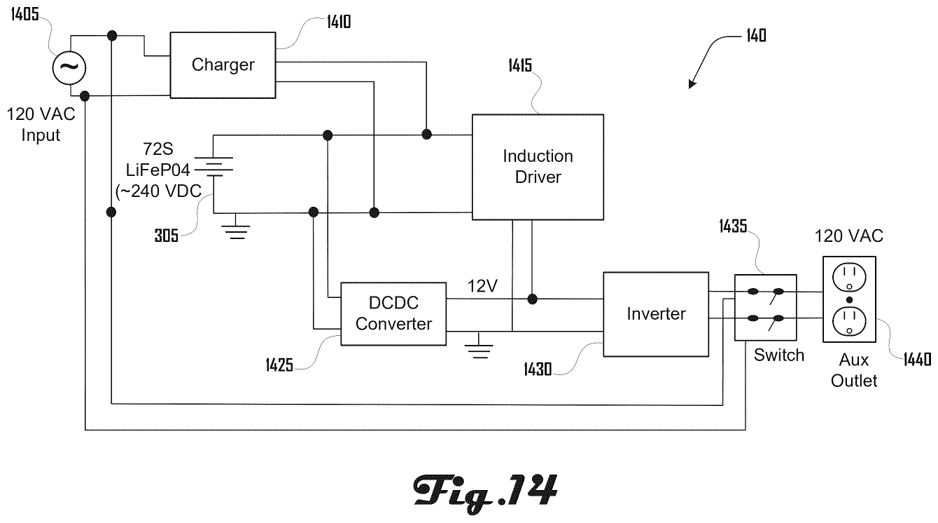

Turning to FIG. 14, another example embodiment of a load source system 1200 is illustrated, which comprises an electrical input 1405, a charger 1410, an induction driver 1415, a battery 1205, a DC-DC converter 1425, and inverter 1430, a switch 1435 and an auxiliary electrical output 1440.

In various embodiments, the electrical input 1405 can comprise a power cord 1210 with a plug 1215 configured to couple with an electrical power receptacle 1294 of a power distribution system 1290 (see, e.g., FIG. 12); however, various suitable elements can be part of an electrical input 1405 and such an electrical input 1405 can be via a direct-wire connection in various examples as discussed herein. In various embodiments, the electrical input 1405 can be an AC power input that functions to provide a main source of power that can be used to charge and/or power elements of the load source system 1200. The electrical input 1405 may be used to power and charge an auxiliary power source or other power storage systems such as the battery 1205 and/or power other elements such as a processor 1310, memory 1320, clock 1330, control system 1340, communication system 1350, interface 1360 (see, e.g., FIG. 13), or the like. In some examples, an AC power input of the electrical input 1405 may be a 120VAC (and/or 240VAC) from a wall outlet (e.g., standard 15 A outlet).

In various embodiments, the charger 1410 can comprise a power converter or a battery charger that manages a flow of electrical energy from the electrical input 1405 to the battery 1250 and/or induction driver 1415. For example, in some embodiments, the charger 1410 can convert an AC voltage (e.g., 120VAC or 240VAC) from a wall outlet into a suitable DC voltage required to charge the battery 1205, which can involve rectification (converting AC to DC) and regulation (ensuring the DC output is stable and suitable for the battery). In some examples, an AC/DC regulator in an AC/DC conversion module of the charger 1410 may be used to transform the power input from the electrical input 1405. The charger 1410 in various embodiments can monitor and control the charging process of the battery 1205 to ensure it is charged efficiently and safely, preventing overcharging or overheating, and can manage the charging current and voltage according to the specifications of the battery 1205.

In various embodiments, the charger 1410 and/or battery 1205 can supply DC power to the induction driver 1415 to drive one or more induction coils to generate an electromagnetic field for heating. For example, in various embodiments, the induction driver 1415 can be configured to be powered only by the charger 1410; powered only by the battery 1205; and/or powered by both the charger 1410 and the battery 1205 at the same time. As discussed herein, such powering capabilities can be desirable in various examples to allow for cooking via power from the battery 1205 while power from the electrical input 1405 is unavailable or undesirable such as when there is a power outage or when power obtained from the electrical input 1405 is undesirably expensive (e.g., when such power obtained from a power grid is expensive). Such powering capabilities can be desirable in various examples to allow for a combination of power from the electrical input 1405 and battery 1205 to be used, which can allow for greater power to the induction driver 1415 than would be available from the electrical input 1405 alone, which can allow a stove 130 to perform near, at, or above the capability of a stove 130 powered by 240VAC, even though the stove 130 is powered by only 120VAC via the electrical input 1405. Such powering capabilities can be desirable in various examples to allow for a combination of power from the electrical input 1405 and battery 1205 to be used, which can allow for a reduced amount of power consumed from the electrical input 1405, which may be desirable when power obtained from the electrical input 1405 is unstable, inconsistent, or undesirably expensive (e.g., when such power obtained from a power grid is expensive) or when it is desirable to draw less power from the electrical input 1405 (e.g., where a circuit does not support drawing full power because of other appliances on the circuit). Such powering capabilities can be desirable in various examples to allow for the induction driver 1415 to be powered via the electrical input 1405, when it is undesirable to use power from the battery 1205, when the battery 1205 is out of power, when the battery 1205 is malfunctioning, when the battery 1205 is overheating, when power from the electrical input 1405 is obtained from a renewable source (e.g., solar), or the like. As discussed herein, various additional and/or alternative elements can be powered via DC power from the charger 1410 and/or battery 1205, so the example of an induction driver 1415 should not be construed to be limiting.

For example, the load source system 1200 may additionally or alternatively power resistive, bake, convection and/or broiler heating elements of an oven. Further elements can include convection fans, cooling fans, oven lamps, status indicators (e.g., LEDs, displays, audio systems), user interface displays, external-facing USB ports (and their devices), speakers, externally daisy-chained high-voltage DC devices, and the like. Some of these elements may require a DC/DC regulator or a DC/AC inverter downstream (e.g., of a battery's 240VDC) in order to operate. Some of these elements, such as the convection fans and oven lamps, may be enabled via manual control (e.g., a rocker switch), while others may be enabled via autonomous software control (e.g., via the control system 1340).

The auxiliary electrical output 1440 in various embodiments can comprise a standard electrical receptacle (e.g., 120VAC receptacle) disposed on a housing of a load source (e.g., a stove 130) that allows various other appliances, tools, or the like to be plugged into and powered by the load source system 1200. In various embodiments, the electrical input 1405 and/or battery 1205 can directly or indirectly supply AC power to the auxiliary electrical output 1440. For example, in various embodiments, electrical output 1440 can be configured to be powered only by the electrical input 1405; powered only by the battery 1205; and/or powered by both the electrical input 1405 and the battery 1205 at the same time. As discussed herein, such powering capabilities can be desirable in various examples to allow for auxiliary power from the battery 1205 while power from the electrical input 1405 is unavailable or undesirable such as when there is a power outage or when power obtained from the electrical input 1405 is undesirably expensive (e.g., when such power obtained from a power grid is expensive). Such powering capabilities can be desirable in various examples to allow for a combination of power from the electrical input 1405 and battery 1205 to be used, which can allow for greater power to the auxiliary electrical output 1440 than would be available from the electrical input 1405 alone, which can allow the auxiliary electrical output 1440 to perform near, at, or above the capability of a stove 130 powered by 240VAC, even though the load source system 1200 is externally powered by only 120VAC via the electrical input 1405. Such powering capabilities can be desirable in various examples to allow for a combination of power from the electrical input 1405 and battery 1205 to be used, which can allow for a reduced amount of power consumed from the electrical input 1405, which may be desirable when power obtained from the electrical input 1405 is unstable, inconsistent, or undesirably expensive (e.g., when such power obtained from a power grid is expensive) or when it is desirable to draw less power from the electrical input 1405 (e.g., where a circuit does not support drawing full power because of other appliances on the circuit). Such powering capabilities can be desirable in various examples to allow for the auxiliary electrical output 1440 to be powered via the electrical input 1405, when it is undesirable to use power from the battery 1205, when the battery 1205 is out of power, when the battery 1205 is malfunctioning, when the battery 1205 is overheating, when power from the electrical input 1405 is obtained from a renewable source (e.g., solar), or the like. In some embodiments, the electrical input 1405 (e.g., 120VAC from a wall receptacle) provides power to a dedicated, external-facing ‘auxiliary power’ inverter, which can function as a default passthrough for preserving the battery state of charge and avoiding power conversion losses (and the associated noise from fans).

One or more auxiliary electrical output 1440 may be integrated into the load source system 1200 in a convenient accessible location such as on the front of a stove 130 near the floor, behind a cover on the top of the stove 130, in a reachable location on the back of the stove 130, affixed with a small whip to allow the user to move the outlet to the kitchen counter near to the stove 130, on the top of the stove 130 with a fluids cover, and/or in any suitable location.

The auxiliary electrical output 1440 may comprise a NEMA 5-15 or NEMA 5-20 plug in some examples. The auxiliary power port 1440 in some examples may provide standardized AC power (e.g., 120 VAC power). DC auxiliary power ports in some alternative form (e.g., a USB port) may additionally or alternatively be included. The auxiliary electrical output 1440 can be powered in some embodiments by a DC battery and may connect to an internal inverter to convert the power from DC to AC.

An auxiliary power port 1440 in some embodiments can be ‘full power’ or provide the max available power of 2400 w (nema 5-20) or 1800 w (nema 5-15), or the like. An auxiliary electrical output 1440 in some examples can alternatively or dynamically provide less power, such as 1000 w, 500 w or 300 w, or the like.

The auxiliary electrical output 1440 in some embodiments may be integrated into the load source system 1200 as a passthrough system whereby a device could be plugged in to the auxiliary electrical output 1440 and the power may by default be supplied via the AC power input, but then during a power outage or during other suitable situations, the load source system 1200 can switch over to providing power via the battery 1205.

The load source system 1200 in some embodiments can additionally or alternatively include a DC auxiliary electrical output 1440. This may provide a DC power rail in some examples. The DC auxiliary electrical output 1440 may be used in various ways including to power an additional induction burner in some examples. Such an additional induction burner could be modular and could be placed on a nearby countertop to provide more stovetop capacity while cooking a larger meal. In another variation, a DC auxiliary electrical output 1440 may be used to power an external inverter which could be used to provide AC power to a high-power device like an air fryer, a dishwasher, and the like. In some variations, a DC auxiliary electrical output 1440 may be used to connect an external battery, which could be used as additional power storage capacity.

Additionally, or alternatively, one or more additional or alternative power inputs may be used as a power source, which may be AC and/or DC. For example, in some embodiments the electrical input 1405 can be DC power. In some embodiments, there can be one or more additional DC power inputs in addition to an AC electrical input 1405.

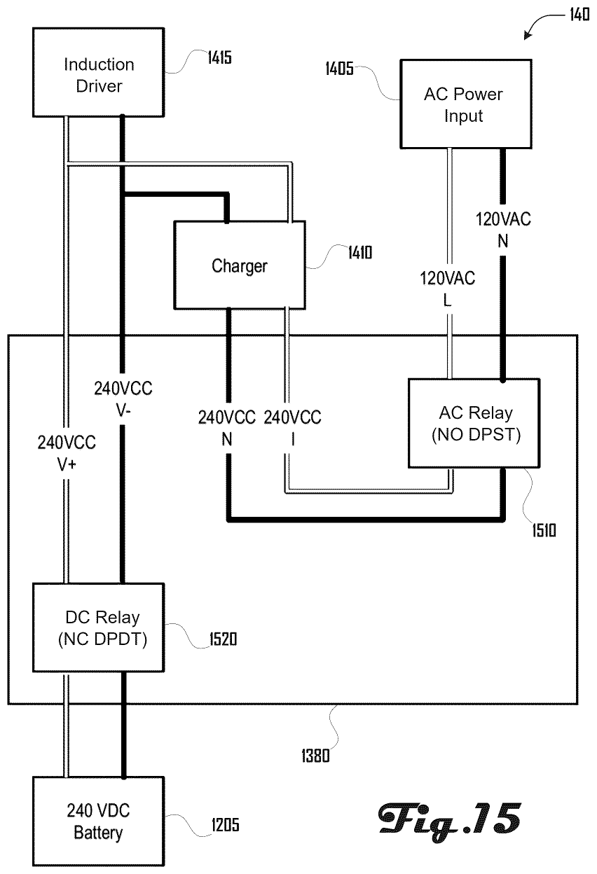

In various embodiments, an AC/DC conversion module 1380 (see, e.g., FIG. 13) functions to transform AC power input from electrical input 1405 and output DC power to charge the battery 1205, induction driver 1415, or the like. For example, as shown in the embodiment of FIG. 15, an AC power input may enter an AC/DC conversion module 1380 through an AC relay 1510 (e.g., normally open (NO) and double-pole, single-throw (DPST)) prior to going to a charger 1410. The charger 1410 can output a DC signal (e.g., 230VDC) that may connect to the induction driver 1415 and/or to a battery 1205 via a DC relay 1520 (e.g., normally closed (NC) and double-pole, double-throw (DPDT)).

DC power (e.g., nominally 240VDC) from the charger 1410 may be provided to the battery 1205 by way of a safety relay in various examples. Current from the battery 1205 can be provided to various elements of the load source system 1200 by way of a safety relay and can serve as a source for powering elements such as a processor and/or safety triggers of the load source system 1200 by way of a DC/DC regulator.

The AC power input 1405 may connect (e.g., with a cord and plug) to an electrical receptacle (e.g., common receptacle with 120VAC 15 A, 20 A, or the like or an appliance outlet with 230VAC with 20 A, 30 A, 50 A, or the like) to provide outside power to the load source system 1200. The AC/DC conversion module 1380 can use the AC power input from the power input 1405 to charge the battery 1205 source, used to charge supplementary battery systems or directly power various systems or elements.

In some variations, the amount of current drawn from the power input 1405 may be limited in some embodiments (e.g., through a configuration setting). For example, the limit may be set below 10 A, 15 A, 20 A, 30 A, 50 A, or the like. For example, in a retrofit kitchen, there may be insufficient circuit capacity to operate all appliances at once so a stove 130 having a load source system 1200 can be configured to draw less power. For example, a toaster and a microwave might be on the same circuit as a stove 130 having a load source system 1200 and the stove 130 can be configured to lower maximum charging rate to facilitate operation of all appliances on the circuit.

In some embodiments, a load source system 1200 can include a monitoring system that monitors incoming AC voltage of a shared branch circuit. During times of high use, the voltage can sag, and the load source system 1200 can automatically lower charging current of the load source system 1200 to accommodate (e.g., to avoid tripping the circuit breaker). Because the sensing and/or control can be part of the load source system 1200, techniques like synchronous source detection may be used in some examples to calibrate out differences in grid voltage and for other applications.

An AC/DC conversion module 1380 of some embodiments may output a DC power output (e.g., nominally 240 VDC), which as described may be provided to a battery 1205 by way of a safety relay in some examples. The charger 1410 and/or the battery 1205 may be provided to elements of the system load source system 1200 by way of a safety relay and may serve in some examples as the main source for powering one or more processors and/or safety triggers by way of a DC/DC regulator.

In some embodiments, DC power may primarily be used to directly power the high-load elements of the load source system 1200. In a stovetop embodiment, the load source system 1200 can include an induction heating module, which can function to perform induction heating. The induction heating module may include induction coil drives and/or interface with an integrated induction stovetop module. In some cases, the load source system 1200 may be configured to interface with an outside or existing heating element. Alternatively, the heating element may be directly integrated and/or customized with the load source system 1200.

As discussed, the load source system 1200 in various embodiments can include one or more supplementary battery systems, which may be used as a backup to the battery 1205. In some variations, such a supplementary battery system may be or include a battery-equipped Uninterruptible Power Supply (UPS); for example, in the event of a grid blackout and/or dead or disabled battery 1205, to maintain some level of continuous processor operation (e.g., to continue logging events), the battery-equipped UPS can keep the processor(s) powered.

In order to satisfy a suitable safety standard (e.g., meet UL standards), in some embodiments there may be a series of redundant controls that can independently (e.g., without software) disable/disengage some or all potentially hazardous aspects of the load source system 1200; for example, power to the charger 1410; the output of high-voltage batteries; some or all connections powered off high-voltage batteries, and the like. Such a control scheme may include thermal fuses, current fuses, insulation fault detectors, or some combination thereof, whereby one tripped fuse can disconnect the trigger signal to the normally controlled relays that control the pathways and/or subsystems. Temperature fuses in some examples may be configured to trip/trigger at determined temperature points and may be oriented inside or near an oven, stovetop, and high-voltage battery. Current fuses may be integrated inside the battery 1205 (e.g., integral to a battery management system (BMS)). Additional safety measures may include Ground Fault Protection between the one or both terminals of a DC signal (e.g., 240VDC) and the systems chassis (e.g., range chassis), and a Ground Fault Protection between an auxiliary AC power outlet 1440 and the chassis of the range.

Some variations of a load source system 1200 and/or a method implemented by a load source system 1200 can be configured to boost preheating capabilities of an oven or other heating element, and the like. The load source system 1200 may be configured to implement process of a method that includes using the battery 1205 to provide high instantaneous power output. This may be used to enable a “boost” mode for use during preheating or in other situations. Some convection ovens can utilize a rear convection element (e.g., positioned around a fan) and a top element which can principally be used for broiling. A broiling element may be used to boost the power of the oven during preheating in some examples. This may be performed in some embodiments when no food is in the oven to avoid burning of the food. Because a battery enabled stove of various embodiments can output higher instantaneous power than a conventional wired stove, this boost mode can be made to be quite powerful. In one example, a time of 5 minutes could be sufficient to preheat to 400 degrees Fahrenheit during such a boost mode, which could, for example, be two to three times as fast as a conventional pre-heating cycle.

In some embodiments, instead of using a power inverter to create AC power for a conventional oven fan (e.g., driven by a shaded pole motor) and/or oven light, DC-driven versions of an oven fan and/or oven light may be used. In some such variations, the driving circuitry can rely on a DCDC converter, which may be smaller and cheaper. These DC fans and/or lights may use proportional control, which in the case of the fan, can be used to modulate airflow, limit noise, create more even oven temperatures without convection baking the food. In the case of the light, a light can create softer lighting conditions, or be used to communicate information to the user, such as whether the oven is preheated, or if the food is done cooking.

Some variations of the load source system 1200 and/or a method implemented by the load source system 1200 may be configured to reduce or eliminate undesirable audible and tactile artifacts associated with AC's low-frequency envelope imposed on the generated electromagnetic field. In some induction systems driven by an AC signal, the envelope of an AC signal (e.g., 60 Hz, 120 Hz) can drive the induction system which can be both felt (vibrations) and heard. The load source system 1200 and/or method implemented by the load source system 1200 can use the DC signal which has a flat envelope such that the electromagnetic effects causing audible or tactile vibrations can be eliminated or reduced.

The use of a DC input in some examples can reduce the size of components used in driving an induction heating system. In AC-driven induction systems, bulky ripple capacitors may be used which are both expensive and large. Ripple capacitors can also reduce the overall efficiency of the circuit and reduce the power factor. Some AC-driven systems can require a PFC circuit and/or EMI/RFI circuits, which may be eliminated or simplified in the system when powering from a line-isolated DC battery. The system's DC input to an induction system, avoiding the need for such components, may result in a more energy efficient load source system 1200 in some embodiments.

In some variations, the load source system 1200 may include cascaded DC and AC relays. The load source system 1200 may include a single DC relay to control a plurality of AC relays in some examples. By using a DC relay to switch first, in some embodiments the AC relays can be switched in a dry state to minimize or reduce contact arcing issues that can be associated with AC relays. This may also help to prolong the life of the contacts and reduce maintenance costs. Additionally, a single DC relay can be used to control multiple AC relays, which can simplify the wiring and control systems, and reduce the overall cost of the load source system 1200.

In some variations, a DC powered approach of the load source system 1200 or method implemented by the load source system 1200 may enable usage of Metal-Oxide-Semiconductor Field-Effect Transistors (MOSFETs) to switch power to high powered loads. For example, MOSFETs may be used to switch 230VDC 20 A power to an oven bake/broil heating element in some embodiments. MOSFETs may have increased switching life over other switching elements that can be used in AC operated ovens. This may result in increased life, easier maintenance, and/or more accurate temperature control because of an ability to rapidly switch between power states. As one potential benefit, a system variation using FET control with faster cycling may provide more latitude to control when each of the oven elements is on, to coordinate the power draw of each in order to limit the total power draw of the stove 130.

In some variations, the load source system 1200 may include a maximum power point tracker (MPPT) which may function to enable the load source system 1200 to accept power generated locally by a solar panel, wind turbine, or other source of power generation. This solar powered solution may be more generally applied as part of a general energy storage equipped (ESE) appliance, which may be a range stove 130 as described herein but could be any suitable type of appliance. In some variations, the ESE could be a water heater or heat pump or other suitable load source as described herein.

In one example, energy can be generated by a solar panel, and pass through the MPPT into the battery 1205 of the ESE appliance. This energy in various embodiments can augment power received from a receptacle 1294 to the ESE appliance and can limit the total amount of power drawn from a home's power distribution system 1290 by the ESE appliance. In some variations, the load source system 1200 may be configured to avoid “backfeeding” of the home's electrical system or the grid, which may mean this kind of installation can take place without permission of a utility in some examples, thereby leading to simplified installation.

In some variations, the load source system 1200 can include an interface subsystem to facilitate interfacing with an induction driver 1415 (see FIG. 14). Interfacing with an induction driver 1415 may enable the load source system 1200 to be used with existing induction drivers 1415 provided by other outside load source system 1200. An interface subsystem may be configured to enable a process that when performed causes creating a DC current measurement and feeding the DC current measurement to a driver and synthesizing 120 Hz signal (or other suitable frequency). This solution may be internationally deployable by adapting the frequency to any desirable frequency.

In order to make an existing, traditionally AC-powered induction driver 1415 work off a DC voltage (e.g., power from the battery 1205), the induction driver 1415 can be augmented with a controller that provides synthesized AC signals to it that satisfy a variety of conditions it may need met in order to operate. For example, an induction driver 1415 may regularly measure the amplitude and/or frequency of the input power signal to ensure that components of the induction driver 1415 can properly operate or synchronize off this signal (e.g., to improve power factor by switching at the signal's zero-crossing) or that such a signal is being cleanly powered and will not propagate as radiated noise or that the signal is electrically safe to pass through. Because the induction driver 1415 is being powered off DC in various embodiments, the variability of an AC signal may no longer be relevant. Thus, the operation of the induction driver 1415 can become geographically agnostic and can be deployed anywhere without special SKUs.

In one variation, a load source system 1200 and/or method implemented by the load source system 1200 may include a slow preheat/capped burner power mode, which can function to preserve energy stored by the battery 1205. A control system may be used to manage operations of the device to adjust for stored power availability, predicted power availability from an AC power input 1405 or some other power source in coordination with predicted usage of the appliance (e.g., time of day, cooking habits, etc.). In some embodiments, a load source system 1200 and/or method implemented by the load source system 1200 may use time and/or usage-based charging profiles. Charging of the auxiliary power source and appliance heating capabilities may be adjusted to meet expected requirements. Some examples of such methods are disclosed in related U.S. patent application Ser. No. 17/692,714, filed Mar. 11, 2022, entitled “APPLIANCE LEVEL BATTERY-BASED ENERGY STORAGE,” with attorney docket number 0122186-001US0 which is incorporated herein by reference.

In another variation, a load source system 1200 and/or method implemented by the load source system 1200 may include detecting circuit breaker (for shared branch circuit) overdraw by measuring voltage sag from wall. In another variation, a load source system 1200 and/or method implemented by the load source system 1200 may use special heating modes. For example, a load source system 1200 and/or method implemented by the load source system 1200 may include anti-warping heating profiles for pans, which may function as a gentle mode to prevent distortions or deterioration of cookware.

In another variation, a load source system 1200 and/or method implemented by the load source system 1200 may operate to manage power storage of the battery 1205 based on external data sources. In one such example, the load source system 1200 may charge the battery 1205 when emissions intensity is below a threshold, based on external data.

In another variation, a load source system 1200 and/or method implemented by the load source system 1200 may use alternative heating approach to mitigate heating of a battery 1205. For example, a load source system 1200 and/or method implemented by the load source system 1200 may use an upper oven element to assist a convection element so that lower element is not needed or used less, which may mitigate heating of a battery 1205 stored below the oven.

In another variation, a load source system 1200 and/or method implemented by the load source system 1200 may use various sensing approaches. A load source system 1200 and/or method implemented by the load source system 1200 may use multi-probe oven chamber sensing. This may involve sensing and detecting uniformity of heat, and if a large enough temperature difference is detected, the load source system 1200 can run convection fan for air mixing. A load source system 1200 and/or method implemented by the load source system 1200 may additionally include detecting operation of an oven fan (e.g., detecting a broken oven fan) and/or controlling the fan for augmented cooking.

In some variations, the load source system 1200 may integrate the battery 1205 into the load source system 1200 in particular locations for enhanced usability and functionality. The location of the battery 1205 in residential ranges for an enhanced induction range system can be desirable to ensure the efficient and safe operation of a range. One first variation can be to place the battery below the oven, within a defined cavity (e.g., where a range warming drawer may be located). In some variations, the battery 1205 may be physically integrated into a warming drawer. In some variations, a battery 1205 may replace a warming drawer in the appliance, or simply be below the oven. This location in various embodiments can provide access to cool air (e.g., due to a natural thermocline of the room) on the floor. The air may be utilized either passively or through forced convection to cool the battery 1205 without having to pipe the air around the stove.

Additionally, having the battery 1205 as low as possible or as close to the ground as possible can provide mechanical stability, acting as a counterweight to prevent the stove from falling over when the oven door is open. The battery 1205 can transfer the weight directly onto the ground through feet attached to the stove or through the feet of the stove, minimizing the amount of material required to transfer the weight to the ground. Alternatively, weights (e.g., cement blocks or other counterweights) may be mounted or installed at the base of the stove. Additionally or alternatively, the load source system 1200 may be mounted or fixed in position using brackets and screws.

Another variation can be to place a flat battery pack behind the stove, utilizing the space behind the stove. This location can provide a compact design of the stove, can enhance the aesthetic appeal of the stove and may not interfere with the operation of the stove. Depending on the specific design and dimensions of the enhanced induction or electric stove system, other locations can also be suitable for placing the battery.

In some variations, the load source system 1200 may include battery fixturing that may facilitate moving or accessing a battery 1205. This may be useful to enable cleaning, maintenance, and the like. The battery 1205 may include feet of a material with low resistance (e.g., Delrin, Teflon, etc.) to enable the battery 1205 to slide without loading attachment points to the stove 130. In another variation, the battery 1205 may be attached to the stove 130 but have rolling feet. The load source system 1200 in some examples may include design features to facilitate installation and servicing accessibility. The battery 1205 and/or associated components may use connectors and fixturing mechanisms for ease of connecting power plugs and accessing the components of the battery 1205 and/or associated components.

The battery 1205 may be a detachable unit in some examples, which may enable the battery 1205 to be supplied separately. This may be useful to allow for changing of a battery 1205 and installation of the battery 1205 into a previously set up appliance, swapping of a battery 1205, or the like.

The battery 1205 in various embodiments may include safety features to ensure that the battery 1205 is used when the battery 1205 is properly installed and in a safe operating condition. A battery control system that may be part of an auxiliary power source system may measure and record the state of the battery 1205 through one or more sensors, which may include but is not limited to accelerometers, switches, thermometers, and the like.

In some variations, the battery 1205 may include a protective casing or layer, which can be a component encasing the battery 1205 in a protective material to ensure protection from fire. This may be designed to provide the battery 1205 with at least 60 minutes or at least 120 minutes of protection in a building fire, or the like. For example, gypsum or similar fire retardant or phase-change material may be used. The load source system 1200 in some embodiments may include a battery cooling system which in some examples can be a special cooling fan that activates only when needed to cool battery/oven interface.

A load source system 1200 and/or method implemented by the load source system 1200 may include an integrated safety system for addressing possible electrical safety issues. In the case of a cooking range, possible issues that may be mitigated can include detection of an oven over-temperature event, detection of a battery over-temperature event, and detection of an electrical hazard (e.g., insulation fault, incorrect installation, damaged battery, DC isolation fault, AC hazard, and the like).

In some embodiments, a method of safety system activation can comprise a determination that there is an oven over-temperature event present, that a battery over-temperature event is present, or that an electrical hazard event is present (e.g., by a control system 1380 based on data from one or more sensors 1390). In response, a safety system (e.g., safety circuit) can cause a suitable response, which can include a battery cut-out, a charger cut-out, grounding, ground fault circuit interruption (GFCI), and the like. In various examples, an over-temperature event can be determined based at least in part on data or physical response from a temperature sensor indicating a temperature above a given threshold for an amount of time.

In some embodiments, a safety system may enable safe operation of a battery electric range, with the battery 1205 in close proximity to the oven 140 and/or cooktop 144. In some examples, over-temperature of the battery 1205 can cut off the oven 140, and over-temperature of the oven 140 can cut off the battery 1205, to ensure both are operating safely. Similar methods can be applied to other appliances or elements of a range or stove 130.

In some embodiments, the same set of relays may be used to perform activation of a plurality of safety measures (e.g., not multiple independent pairs of relays), with such safety measures including one or more of responding to a determined oven over-temperature event, responding to a determined battery over-temperature event, and responding to a determined electrical hazard event.

In some examples, a string of over-temperature cut-offs can be associated with various heat sources generally or specifically such as the battery 1205, oven 140, cooktop 144, heating zones 132, and the like. In some embodiments such a string may have redundant over-temperature cutoffs for some or all such heat source locations. In some embodiments, two or more independent strings can have just one over-temperature cut-off at some or all such heat source locations. Various suitable sensors can be used for sensing temperature and generating an over-temperature cut-off response including thermal fuses, thermostats, thermocouples, thermistors, PTC (Positive Temperature Coefficient) devices, RTDs (Resistance Temperature Detectors), bimetallic switches, IC temperature sensors, thermal cut-out switches, and the like.

Redundant relays in some embodiments can be configured to stop some or all heating of the load source system 1200 by cutting off the battery 1205 and/or by cutting off the charger 1410, or the like. Such a cutoff can be configured to de-power the oven 140, cooktop 144, heating zones 132, or other elements, including heat sources and non-heat sources. In some embodiments, at least some non-heat sources can remain active after such a cutoff such as an interface 1360, processor 1310, control system 1340, communication system 1350, and the like.

In some embodiments, the same or different cut-off relays can be configured to respond to electrical hazards, such as electrical hazards posed by insulation, isolation faults of the battery system, and the like. In some embodiments, a sensor string can have additional sensors or relays as part of the sensor string, which can be configured to open when an electrical fault is detected, thus triggering power cut-off relays.

In some embodiments, relays that perform a battery cut-off can be disposed within a battery enclosure, and in some examples can be configured to perform a safety function of preventing the battery from energizing unless it is correctly installed into the product (e.g., in an embodiment where the battery is removable). For example, in some embodiments, a string of sensors cannot be completed without the battery 1205 correctly installed into the load source system 1200, such that with a battery 1205 not installed or incorrectly installed (e.g., battery connections improperly or incompletely seated), cut-off relays disabling battery power cannot turn on unless the battery 1205 is installed into the load source system 1200.

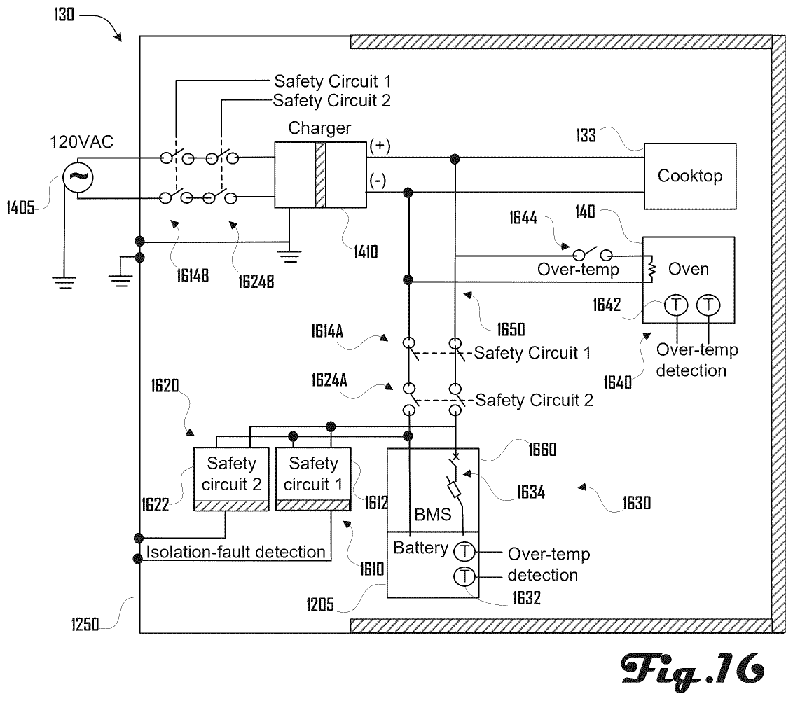

Turning to FIG. 16, an example embodiment of a load source system 1200 of a stove 130 is illustrated, which comprises a plurality of safety systems 1610, 1620, 1630, 1640. The load source system 1200 in this example comprises a first safety system 1610 that comprises a first safety circuit 1612 and two switch pairs 1614A, 1614B. The load source system 1200 in this example further comprises a second safety system 1620 that comprises a second safety circuit 1622 and two switch pairs 1624A, 1624B.

In various embodiments, the first and second safety circuits 1612, 1622 can be connected to the housing 1250 of the oven 130 and connected to a string 1650 connected to the battery 1205, a battery management system 1650, an oven 140, a cooktop 144 and a charger 1410. The first and second safety circuits 1612, 1622 can be configured to actuate switch pairs 1614A, 1624A disposed in parallel on the string 1650. In various embodiments, actuating at least one of the switch pairs 1614A, 1624A on the string 1650 can cause the battery 1205 to be disconnected from the oven 140, cooktop 144 and charger 1410, which can prevent or stop electrical power flowing to and/or from the battery 1205 to and/or from the oven 140, cooktop 144 and charger 1410. For example, actuating at least one of the switch pairs 1614A, 1624A on the string 1650 can prevent or stop the charger 1410 from charging the battery 1205; prevent or stop the battery 1205 from powering the oven 140; prevent or stop the battery 1205 from powering the cooktop 144; and the like. Such a configuration can be desirable in various embodiments to cut power to heating elements such as the oven 140 and/or cooktop 144 in response to a determined or detected safety event by the first and/or second safety circuits 1612, 1622. Such a configuration can be desirable in various embodiments to cut power being provided to the battery 1205 in response to a determined or detected safety event by the first and/or second safety circuits 1612, 1622.

The first and second safety circuits 1612, 1622 can be configured to respectively actuate the switch pairs 1614B, 1624B disposed between the AC electrical input 1405 and charger 1410. In various embodiments, actuating at least one of the switch pairs 1614B, 1624B between the AC electrical input 1405 and charger 1410 can cause the charger 1410 to be disconnected from the AC electrical input 1405, which can prevent or stop electrical power flowing to the charger 1410 from the electrical input 1405. For example, actuating at least one of the switch pairs 1614B, 1624B can prevent or stop the charger 1410 from charging the battery 1250; prevent or stop the charger 1410 from powering the oven 140; prevent or stop the charger 1410 from powering the cooktop 144; and the like. Such a configuration can be desirable in various embodiments to cut power to heating elements such as the oven 140 and/or cooktop 144 in response to a determined or detected safety event by the first and/or second safety circuits 1612, 1622. Such a configuration can be desirable in various embodiments to cut power being provided to the battery 1205 in response to a determined or detected safety event by the first and/or second safety circuits 1612, 1622.

In various embodiments, the first and second safety circuits 1612, 1622 can respond to electrical hazards such as an insulation fault, an incorrect installation, damaged battery, DC isolation fault, AC hazard, and the like. In various embodiments, the first safety circuit 1612 can be configured to simultaneously trip the switch pairs 1614A, 1614B, which can be configured to stop or prevent power to heating elements such as the oven 140 and/or cooktop 144 based on power from the battery 1205 and/or the electrical input 1405. Such a configuration can be desirable in various embodiments to cut power to heating elements such as the oven 140 and/or cooktop 144 in response to a determined or detected safety event by the first and/or second safety circuits 1612, 1622, regardless of whether the oven 140 and/or cooktop 144 are being powered by one or both of the battery 1205 and power from the electrical input 1405.

In various embodiments, the load source system 1200 of the stove 130 can comprise a third safety system 1630 associated with the battery 1205, which can comprise at least one battery temperature sensor 1632 associated with the battery 1205, which can be configured to sense a temperature of the battery 1205, which can be used to make a determination that the battery 1205 is above a threshold temperature for a threshold amount of time. In response, the third safety system 1630 can trigger a battery switch 1634, which can prevent or cut power being provided to the battery 1205 and/or prevent or cut power being provided by the battery 1205. Such an embodiment can be desirable for identifying or determining presence of a battery over-temperature event and responding by generating a battery cut-out.

In various embodiments, the third safety system 1630 can comprise any suitable number of battery temperature sensors 1632 of any suitable type(s), which can be disposed, in, on or about the battery 1205, including in some examples as part of a battery management system 1660 associated with the battery 1205. In various examples, the battery switch 1634 can be part of a battery management system 1660, or disposed in any other suitable location.

In various embodiments, the load source system 1200 of the stove 130 can comprise a fourth safety system 1640 associated with the oven 140, which can comprise at least one oven temperature sensor 1642 associated with the oven 140, which can be configured to sense a temperature of the oven 140, which can be used to make a determination that the oven 140 is above a threshold temperature for a threshold amount of time. In response, the fourth safety system 1640 can trigger an oven switch 1644, which can prevent or cut power being provided to the oven 140. Such an embodiment can be desirable for identifying or determining presence of an oven over-temperature event and responding by generating an oven cut-out.

In various embodiments, the fourth safety system 1640 can comprise any suitable number of oven temperature sensors 1642 of any suitable type(s), which can be disposed, in, on or about the oven 140, including in some examples as part of an oven system associated with the oven 140. In various examples, the oven switch 1644 can be disposed in any other suitable location.

In further embodiments, other elements of the stove 130 can have associated temperature safety systems, including heating elements such as the cooktop 144, one or more heating zones 132 of the cooktop 144, and the like. Such temperature safety systems can be desirable for identifying or determining presence of an over-temperature event for such elements.

In some embodiments, the same set of relays may be used to perform activation of a plurality of safety measures (e.g., not multiple independent pairs of relays), with such safety measures including one or more of responding to a determined oven over-temperature event, responding to a determined battery over-temperature event, and responding to a determined electrical hazard event.

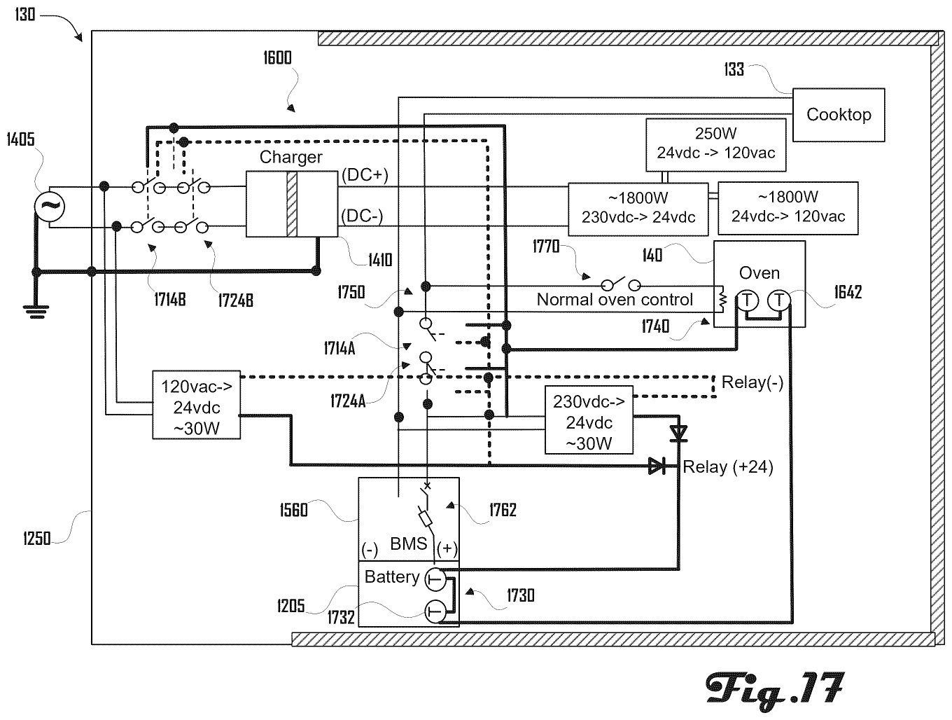

For example, FIG. 17 illustrates an example embodiment of a load source system 1200 of a stove 130 comprising a relay system 1700 configured for responding to a determined oven over-temperature event and responding to at least a determined battery over-temperature event. For example, the relay system 1700 can extend between one or more respective temperature sensors 1732, 1742 of a battery safety system 1730 and oven safety system 1740. The relay system 1700 can further extend between switches 1714A, 1714B, 1724A, 1724B. Accordingly, the relay system 1700 can be configured for responding to both a determined oven over-temperature event and responding to at least a determined battery over-temperature event.

In some embodiments, the switches 1714A, 1724A can be part of 2× Single Pole Single Throw-Normally Open (SPST-NO) switch assembly disposed on a string 1750 between the battery 1205, oven 140, cooktop 144, and charger 1410 that also includes a normal oven control switch 1770 and normal battery switch 1762 that can be part of a battery management system 1660. In some embodiments, the switch pairs 1714B, 1724B can be part of a 2× Double Pole Single Throw-Normally Open (DPST-NO) switch assembly disposed between the electrical input 1405 and the charger 1410. In some embodiments, the switches 1714A, 1714B can be part of a first circuit and the switches 1724A, 1724B can be part of a second circuit. In some embodiments, the relay system 1700 can be configured to respond to a determined electrical hazard event, or the like.

In various embodiments, a load source system 1200 such as a stove 130 can be configured to operate in different operating modes depending on state of the battery 1205. For example, a load source system 1200 can be configured to operate a stove 130 in a full power mode or in one or more limited power mode (e.g., when the battery 1205 is dead or when it is desirable to conserve power stored in the battery 1205 and/or being drawn from a receptacle 1294).

In various embodiments, a benefit of having a load source system 1200 such as a stove 130 that comprises a battery 1205 can be that the stove 130 can be operated even when the power from the grid and/or renewable sources is out, intermittent or limited. To facilitate uninterrupted use of a stove 130 under such condition, in some examples, an interface 1360 can be configured to alert a user about the charge status of the battery 1205 and/or the remaining energy left in the battery 1205 so the user can make informed decisions on how much energy to use while cooking, such as delays in regaining power delivery from a utility or renewable sources; when the cost of energy from the grid is expensive; or the like.

A display or other presentation of energy consumption can be visualized in various suitable ways (e.g., to suit user preferences), such as an absolute percentage of battery capacity remaining, quantity of energy stored in kWh or Wh, an estimated time of exhaustion based on the current energy draw, an average of the last X number of minutes of cooking, and the like. In some embodiments, the load source system 1200 can determine energy consumption using a machine learning approach based on a cooking training dataset (e.g., including data amassed over the life of the stove 130, a moving window of time therein, or the like).

In the case where the battery 1205 is depleted, the user can be notified via the interface 1360, such as via a display 1284, another visual indicator, an audio indicator, or the like. The interface 1360 in various examples can indicate that the stove 130 range will function at limited capacity based on the amount of energy coming from a receptacle 1294 the stove 130 is connected to. In some embodiments, when limited power is available based on lack of power from the battery 1205 or receptacle 1294, the stove 130 can be configured to still have a functional oven 140, but in some examples, the stove 130 can take longer to reach temperature due to operating at lower than full power. In some embodiments, when limited power is available based on lack of power from the battery 1205 or receptacle 1294, the stove 130 can be configured to operate with a reduced number of burners and/or with less than max power output on one or more burners.

In various environments, a load source system 1200 of a stove 130 can be configured to operate in any suitable number of power configurations, including one, two, three, four, five, ten, twelve, or the like. For example, some embodiments can include a full power operating configuration and a minimal operating power configuration, where the minimal operating power configuration provides less operating capacity than the full power operating configuration. Some embodiments can include a full power operating configuration, a first reduced operating power configuration that provides less operating capacity than the full power operating configuration, and a second reduced operating power configuration that provides less operating capacity than the first reduced operating power configuration and full power operating configuration.

Full and reduced or minimum operating power configurations of a stove 130 can provide more or less operating capacity in various suitable ways. For example, in embodiments where a stove 130 comprises an oven 140, a full power operating configuration can allow the oven 140 to operate at 100% power capacity, and one or more reduced operating power configurations can limit the oven 140 to operating at equal to or less than 80%, 75%, 70%, 65%, 60%, 55%, 50%, 45%, 40%, 35%, 30%, 25%, 20%, 15%, 10%, 5%, or the like, or a range between such example values. One embodiment can include a full power operating configuration that can allow the oven 140 to operate at 100% power capacity and a minimum operating power configuration that limits the oven 140 to operating at 50% power or less. Another embodiment can include a full power operating configuration can allow the oven 140 to operate at 100% power capacity, a first reduced operating power configuration that limits the oven 140 to operating at 65% power or less, and a second reduced operating power configuration that limits the oven 140 to operating at 35% power or less.

In embodiments where a stove 130 comprises a cooktop 144 with one or more heating regions 132 (e.g., separate induction burners), a full power operating configuration can allow the one or more heating regions 132 to operate at 100% power capacity, and one or more reduced operating power configurations can limit at least one of the one or more heating regions 132 to operating at equal to or less than 80%, 75%, 70%, 65%, 60%, 55%, 50%, 45%, 40%, 35%, 30%, 25%, 20%, 15%, 10%, 5%, or the like, or a range between such example values. One embodiment can include a full power operating configuration that can allow one or more heating regions 132 to operate at 100% power capacity and a minimum operating power configuration that limits the one or more heating regions 132 to operating at 50% power or less individually or collectively. Another embodiment can include a full power operating configuration that can allow the one or more heating regions 132 to operate at 100% power capacity, a first reduced operating power configuration that limits the one or more heating regions 132 to operating at 65% power or less individually or collectively, and a second reduced operating power configuration that limits the one or more heating regions 132 to operating at 35% power or less individually or collectively.

In some embodiments, where a stove comprises a cooktop 144 with a plurality of heating regions 132 (e.g., 2, 3, 4, 5 separate induction burners, or the like), different power configurations can limit the total number of heating regions 132 that are able to function at the same time. For example, where a cooktop 144 consists of four heating regions 132, a full power operating configuration can allow up to all four heating regions 132 to operate simultaneously and one or more reduced operating power configuration can limit the maximum heating regions 132 operating simultaneously to three, two or one at a time. In some examples, such a limitation can be on specific heating regions 132 or can apply to any sets of two, three or four heating regions 132 of the four heating regions 132.

In various embodiments, once power from a previously unavailable or unused source becomes available, the stove 130 can switch from a limited operation configuration to a fully operational configuration. For example, after operating in a limited operation configuration from only power from the receptacle 1294, as a result of the battery 1205 being depleted or below a minimum charge threshold, once the battery 1205 has charged to a minimum change state (e.g., defined by a set charge percentage or historical data for how the stove 130 has been used), the stove 130 can return to a fully operational configuration based on power from the battery 1205 and receptacle 1294. Such a configuration change can be presented via an interface 1284 in various suitable ways.

In another example, after operating in a limited operation configuration from only power from the battery 1205 as a result of the power from the receptacle 1294 being unavailable or unused, the stove 130 can return to a fully operational configuration based on power from the battery 1205 and receptacle 1294 once power from the receptacle 1294 becomes available or usable (e.g., after a power outage; once the cost of power from the grid is below a cost threshold making it desirable to use; once renewable power becomes available via the receptacle 1294 at a sufficient amount such as to provide full power instead of grid power; or the like).

In various embodiments, the load source system 1200 can determine or predict a time to achieve different operational capabilities. For example, where a stove 130 is operating in a limited capability mode due to the battery 1205 being depleted or having insufficient power, a determination or prediction can be made regarding how long it will take for the battery 1205 to charge to a level where the stove 130 will be able to operate at a greater operational capacity and/or a full operational capacity. For example, where a minimum charge of 10% is required for the stove 130 to operate at full power, a determination can be made regarding the time it will take for the battery 1205 to charge to 10% capacity. Such a determination can be made based on data such as current charging rate, current power use by the stove 130, predicted power use by the stove 130, current charging current, current charging voltage, stages of a charging protocol, and the like.

Similarly, in some embodiments, where a stove 130 is operating in a full operating configuration or a greater than minimum operating configuration, a determination or prediction can be made regarding how long the battery 1205 has sufficient charge to operate at such a level and until the stove will switch to a minimum or lower operating configuration. For example, where a minimum charge of 10% is required for the stove 130 to operate at full power, a determination can be made regarding the time it will take for the battery 1205 to be depleted to below or equal to 10% capacity. Such a determination can be made based on data such as current charging rate, current power use by the stove 130, predicted power use by the stove 130, current charging current, current charging voltage, stages of a charging protocol, and the like.

In some embodiments, an interface 1360 of the load source system 1200 can include a timer counting down to when the stove 130 is predicted to be able to operate at a full capacity configuration; is predicted to be able to operate at greater than a minimum capacity configuration; is predicted to be required to operate at a minimum operating configuration, is predicted to be required to operate at below a maximum operating configuration; and the like. In various examples, an ability of a load source system 1200 to provide information about energy consumption, battery status, and switching between normal and one or more limited modes can enhance the user experience by empowering the user to make informed decisions about their usage of the enhanced induction stove system, thereby optimizing energy usage and user satisfaction. In various embodiments, a load source system 1200 can automatically switch between one or more operational power modes without user interaction, such as when battery charge reaches or exceeds one or more threshold, when battery charge reaches or falls below one or more threshold, or the like. In some embodiments, operational power modes can be configured by a user, such as via an interface 1360 of a load source system 1200.

In various embodiments, load source use data can include data regarding elements of a load source being used, such as an oven 140, one or more heating regions 132 of a cooktop 144, and the like. For example, use data can include the identity of one or more heating regions 132 of a cooktop 144 being used, a power level that a heating region 132 is set at, an amount of power being consumed by a heating region 132, a mode of a heating region 132, a power level that the oven 140 is set at, an amount of power being consumed by the oven 140, a mode of the oven 140, an amount of power being consumed by an auxiliary electrical output 1440, a mode of an auxiliary electrical output 1440, and the like.

In various embodiments, power availability data can include an indication of whether power is available from a battery 1205, an amount of power available from a battery 1205, voltage and/or current available from a battery 1205, an indication of whether power is available from a receptacle 1294, an amount of power available from a receptacle 1294, voltage and/or current available from a receptacle 1294, one or more source of power coming from the receptacle 1294, cost of power coming from the receptacle 1294, and the like.

In various embodiments, determining an operating configuration can be based at least in part on whether power is available from the battery 1205 and/or receptacle 1294. For example, where a determination is made that power from the receptacle 1294 has become unavailable, but power from the battery 1205 remains available, a determination can be made that an operating configuration should be changed to a reduced power configuration from a full power configuration. In another example, where a determination is made that power from the battery 1205 has become unavailable, but power from the receptacle 1294 remains available, a determination can be made that an operating configuration should be changed to a reduced power configuration from a full power configuration. In another example, where a determination is made that power from both the receptacle 1294 and battery 1205 are available after one being unavailable, then a determination can be made that an operating configuration should be changed from a reduced power configuration to a full power configuration.

In various embodiments, power from the battery 1205 may be unavailable due to the battery 1205 lacking charge, lacking charge above a threshold minimum amount, being broken, being absent from the load source system 1200, being improperly installed in the load source system 1200, where using power from the battery 1205 is undesirable, or the like. In various embodiments, power from the receptacle 1294 may unavailable due to a power outage of an electrical grid, lack power generated by a renewable source (e.g., solar, or wind), or where using power from the receptacle 1294 is undesirable due to cost, being from a non-renewable source, or the like.

For example, in some embodiments, a determination can be made to change to a reduced power configuration from a full power configuration when the cost of power from an electrical grid obtained via the receptacle 1294 is above a cost threshold, which may be based on price data, time of day, a selection by a user, or the like. In some embodiments, a determination can be made to change to a full power configuration from a reduced power configuration when the cost of power from an electrical grid obtained via the receptacle 1294 is below a cost threshold, which may be based on price data, time of day, a selection by a user, or the like.

In some embodiments, a determination can be made to change to a reduced power configuration from a full power configuration when power from a renewable source becomes available, when power from a renewable source becomes available at an amount above a threshold, or the like. In some embodiments, a determination can be made to change to a full power configuration from a reduced power configuration when power from a renewable source becomes unavailable, when power from a renewable source becomes unavailable at an amount below a threshold, or the like.

In various embodiments, an operating configuration can be selected based on a mode of the load source system 1200, which in some examples can be selected by a user, set based on a timer, set based on obtained data, and the like. In some embodiments, a mode can include a battery charging priority mode; a renewable energy mode that prioritizes use of renewable energy sources in powering the load source and/or charging the battery 1205; a cost saving mode that prioritizes use of free energy sources such as renewable energy and/or when cost of power from the grid is more affordable; or a performance mode that prioritizes higher functionality of the load source over battery charging, use of renewable energy, cost of power from the grid, or the like.

In some embodiments, a determination can be made to change to a reduced power configuration from a full power configuration when a user switches from a performance mode to a battery charging priority mode. In some embodiments, a determination can be made to change to a full power configuration from a reduced power configuration when a user switches from a battery charging priority mode to a performance mode.

In some embodiments, a determination can be made to change to a reduced power configuration from a full power configuration when a user switches from a performance mode to a cost saving or renewable energy priority mode. In some embodiments, a determination can be made to change to a full power configuration from a reduced power configuration when a user switched from a cost saving or renewable energy priority mode from a performance mode.

In some embodiments, a reduced power configuration can include limiting, stopping or preventing operation of one or more elements of a load source system, and for a stove 130 can include limiting, stopping or preventing operation of one or more of an oven 140, heating zones 132 of a cooktop 144, and an auxiliary electrical output 1440.

In some embodiments, such a method 900 of FIG. 9 can be performed by one or more load source system 1200, a user device, or battery server to configure one or more load source systems 1200. For example, using FIG. 13 for purposes of illustration, in some embodiments, the load source system 1200 can control its own configuration (e.g., via the method 900). In some embodiments, individual load source systems 1200 can be as a group by another device or one of a set of load source systems 1200 (e.g., a primary load source system 1200). Accordingly, load source use data and power availability data can be obtained from a plurality of battery systems 1200 or from a single battery system 1200, which may or may not include communication of such data via a network (e.g., via communication system 1350).

As discussed herein, determining an output configuration can be for various suitable purposes, such as to maximize use of renewable energy sources (e.g., solar panels 115); to maximize storage of power from renewable energy sources; to maximize storage of power from a power grid 110 when such power is at a low or lower cost; to maximize performance of a load source; to maximize energy efficiency of a load source; to maximize energy storage by one or more batteries 1205; to minimize charging time for one or more batteries 1205; and the like. For instance, a shorter nighttime cooking session can be completely covered in some examples by an on-board or associated battery 1205, charged during the day with ample solar resources, while a longer, more demanding nighttime cooking session could be powered jointly by the battery 1205 and low-capacity outlet (e.g., receptacle 1294). In this way, the charge and discharge control laws of the system and/or network can maximize the use of renewable-generated electricity, in some examples, without impacting the experience of the user.

In various embodiments a load source system 1200 can include settings that enable a user (e.g., via interface 1360) to control functional and usability related aspects of the load source system 1200, which in some examples can include a selection of a charging mode, such as based on user preferences, based on external factors, or the like. One embodiment can include a charging mode configured to charge the battery 1205 via a receptacle 1294 during off-peak hours for lower cost and less grid strain. For example, such a charging mode can be based on the time of day, day of the week, month, time of the year, or the like, which can be set by a user, based on historical patterns, or the like. In some examples, such a charging mode can be based on electricity pricing data (e.g., obtained from a utility company), with charging occurring when price drops below a threshold.

Another example charging mode can be configured to keep the battery 1205 topped up all the time in preparation for utility power interruption or other desired use of the battery 1205. Yet another example charging mode can be configured to charge the battery 1205 during times when the electricity supplied to the receptacle 1294 comes from a renewable resource such as solar or that at least prioritizes charging when renewable power is being supplied to the receptacle (e.g., only charging the battery 1205 via renewable power unless the battery 1205 reaches or is below a charge threshold). In various examples, such a charging mode can be based on data obtained regarding power sources, which can include a house server providing information on an amount of power being generated by one or more renewable sources and/or being provided by an electrical power grid.

To provide a user with information about such one or more charging modes, an interface 1360 of the load source system 1200 may display such charging modes on a digital display, along with a short description for each charging mode. In this way, the user can be informed about the options available to them and can choose the charging mode that best suits their needs or preferences.

In a home that has multiple appliances that have built-in batteries 1205 that are networked together, one or more of the appliances may include an integrated control interface. An integrated control interface may be used, for example, to set global energy policies for the network of appliances such as charging after 9 pm or staying charged all the time in case of a blackout. In one example, it can be desirable to instruct a connected mini-split air conditioner to turn off from your stove because the stove is downstairs from the air conditioner, and you are already cooking on the stove. The ability to control appliances from other appliances can allow for embodiments of such appliances that do not have their own interface and rely on other nodes in the appliance network to control them.

In some embodiments, a stove 130 comprising a load source system 1200 can include a temperature cruise control feature that allows users of the stove 130 to dynamically maintain a consistent temperature on one or more heating zones 132 of a cooktop 144. In some examples such a cruise control feature may enable a hybrid approach of mixing power-based control input for a heating zone 132 with temperature control input to the heating zone 132. Such a temperature cruise control feature in some examples can include a power level-based input mode that results in delivering a substantially consistent amount of continuous heat that is adjusted based on a power level (e.g., varying between low, medium-low, medium, medium-high, and high). This can emulate traditional gas stoves with an open loop heating situation where a user has to gauge the temperature and adjust the power level based on the conditions of what is in the pan. An interface 1360 can include a mechanism to engage a temperature cruise control mode. When in a temperature cruise control mode, one or more sensors 1390 (e.g., temperature sensors) may be used to maintain a substantially consistent temperature of the heated pan or cooking element. For example, in some embodiments, each heating zone 132 of a cooktop 144 can be associated with one or more sensor 1390 (e.g., temperature sensor) configured to determine the temperature of a pot or pan at the heating zone 132, the temperature of the cooktop 144 at the heating zone 132, or the like.

In an embodiment, a method of maintaining temperature at a heating zone 132 can comprise obtaining an indication to enter a temperature-maintaining mode at a heating zone 132 of a cooktop 144, and in response, entering the temperature-maintaining mode at a heating zone 132 of a cooktop 144. The method can further include determining a temperature to maintain, which can be based on a user input, user setting, default setting, or the like. The method can further include obtaining temperature data associated from one or more sensors 1390 associated with the heating zone 132 and determining whether the temperature is outside a range from the defined temperature to maintain (e.g., +/−0° C., 0.5° C., 1.0° C., 1.5° C., 2.0° C., 5.0° C., 10.0° C. 25.0° C., 50.0° C. or the like or a range between such example values). Where a determination is made that the temperature is within the range, a current power level of the heating zone 132 can be maintained; however, where a determination is made that the temperature is not within the range, power of the heating zone 132 can be increased or decreased to raise or lower the temperature to be within the temperature range. Such temperature sensing and power regulation can occur automatically at any suitable time interval while the temperature-maintaining mode is engaged. The method can further include receiving an indication to cease the temperature-maintaining mode at the heating zone 132 of the cooktop 144 and returning to a normal or default heating mode. In various embodiments, each of a plurality of heating zones 132 of a cooktop 144 can be configured to be set to different temperatures to maintain in accordance with separate temperature-maintaining modes of the separate heating zones 132.

In one variation, the knob 1282 used to set power level may become the initiator for engaging and/or disengaging a temperature cruise control mode. For example, each burner control knob 1282 may comprise a momentary push button that allows the user to turn on the “maintain temperature” mode once the user has identified a desired temperature for the given heating zone 132. In some examples, the user can be presented with and select a desired temperature setting (e.g., an interface 1360 presents a temperature such as 200° C. that the user can select) or the user can select a temperature without an explicit temperature being indicated by an interface 1360). In some variations, the knob 1282 is not only a rotary element but also has a latching push button that enables the “maintain temperature” mode. Once this mode is enabled, the heating zones 132 can be configured to maintain the specified temperature without the need for the user to continuously check and adjust it. In one example, when the user identifies the ideal temperature based on tangible feedback such as cooking the perfect pancake, they can enable the “cruise control” mode to maintain that temperature consistently, similar to how a car maintains a speed. The “cruise control” mode may disable in some embodiments as soon as the user turns the knob 1282 (or performs another suitable action), giving them control over the burner's temperature and power level. A temperature control cruise control feature of various embodiments can enhance the user experience by providing an intuitive interface for maintaining consistent burner temperatures, optimizing cooking quality and user satisfaction. Also, while the example of knobs 1282 of an interface 1284 are discussed as one example, initiating, controlling and terminating a cruise control mode can be done in various suitable ways such as with various suitable elements of an interface 1360.

In various embodiments, an oven 140 of a stove 130 can comprise a cruise control mode. For example, the oven 140 of a stove 130 may include one or more temperature sensors and a digital temperature control loop that can enable the oven 140 to maintain a temperature within a desired range. In some embodiments, an oven 140 and/or heating zone 132 of a cooktop 144 can include a preheating mode that overshoots a set temperature point during pre-heating of the oven 140 and/or one or more heating zone 132. In some embodiments, a plurality of temperature sensors can provide better determination of the uniformity of temperature in the cavity of an oven 140. An average temperature can be determined based on data from a plurality of sensors 1390 in some examples, and suitable operational adjustments can be applied based on that determined value. In some examples, where data from a plurality of temperature sensors identifies a difference in temperature above a threshold, the load source system 1200 can enable a convection fan of the oven 140 to mix air in the cavity of the oven 140 to generate an increased temperature uniformity within the cavity of the oven 140.

For example, a method of heating an oven 140 can include obtaining data from a plurality of temperature sensors and determining whether a difference between one or more detected temperature is above a threshold difference, and if so, automatically turning on a fan of the oven 140. If a difference between one or more detected temperature is not above a threshold difference, then the fan can be automatically turned off or not turned on. Sampling of data from temperature sensors can occur at any suitable interval.

In some embodiments, a method of power allocation for a localized power grid that includes a battery supplemented appliance includes: in response to an appliance activation, providing power to the appliance, which may include providing battery power to the appliance; in response to external power usage, providing power to the external power usage, which may include providing battery power to the external power usage; and in response to battery depletion, providing power to the battery.

The method in various examples can provide dynamic power allocation for a local energy grid connected to a high-power consumption load source such as a stove 130 comprising an energy storage device (e.g., a battery 1205). The method may function with a load source system 1200 as described herein but may additionally or alternatively be incorporated with any applicable system. Example use cases for such a method can include office buildings, local households, residential type buildings (e.g., apartment complexes, hotels), local communities (e.g., HOAs, condominium communities, gated communities, etc.), data farms, and/or any other type of local energy grid.

Providing power to the load source can enable function of the load source by providing power to the load source once the load source has been activated. In some embodiments, the load source can comprise a high-power consumption stove 130 that may not be able to function powered directly by the local power grid (e.g., a 220V appliance, such as a stove 130, connected to a 110V receptacle 1294). In some embodiments, the load source can comprise a high-power consumption stove 130 that may not be able to fully function powered directly by the local power grid; for example, a 220V appliance, such as a stove 130, connected to a 110V receptacle 1294 that is configured to fully function with 220V power; configured to fully function with greater than 110V power; configured to operate at a limited power configuration at 110V; configured to operate at a minimal power configuration at 110V; and the like.

In other words, some embodiments can include a load source such as a stove 130 comprising a load source system 1200 that is inoperable to operate in a full power configuration based on power from a receptacle 1294 that the load source is plugged into. In some embodiments, such a load source may be inoperable to operate solely via power from the receptacle 1294 that the load source is plugged into and may require a combination of power from the receptacle 1294 and a battery 1205 of the load source system 1200 to operate in a full power configuration (e.g., greater than 110V, at 220V, or the like). In some embodiments, such a load source may be inoperable to operate in a full power configuration solely via power from the receptacle 1294 that the load source is plugged into and may require a combination of power from the receptacle 1294 and a battery 1205 of the load source system 1200 to operate in a full power configuration (e.g., greater than 110V, at 220V, or the like), but may be able to operate in a reduced, low or minimal power configuration solely via power from the receptacle 1294 that the load source is plugged into. In some embodiments, the load source system 1200 may be able to operate in a first reduced power configuration solely via power from the receptacle 1294 that the load source is plugged into; able to operate in a second reduced power configuration solely via power from the battery 1205 of the load source; able to operate in a third reduced power configuration via a combination of power from the receptacle 1294 that the load source is plugged into and via power from the battery 1205; and able to operate in a full power configuration via power from the receptacle 1294 that the load source is plugged into and from power from the battery 1205. In various embodiments, the first, second and third reduced power configurations can have reduced operating capability of the load source compared to the full power configuration. In various embodiments, the first and second reduced power configurations can have reduced operating capability of the load source compared to the third power configuration.

In various examples, such embodiments can be desirable for providing operability of a load source when power from the battery 1205 is unavailable or undesirable to use; when power from the receptacle 1294 is unavailable or undesirable to use; and/or when power from both the receptacle 1294 and the battery 1205 are available and desirable to use.

In various embodiments, providing power from the battery 1205 to the load source can function to provide supplementary power to the load source in addition to or as an alternative to power from the receptacle 1294, such that the load source may operate in one or more power configuration. In some variations, not all load source functionalities may require supplementary power, thus power from the battery 1205 may be provided in some examples only when additional power is necessary for the load source to function.

In some variations, a method may be implemented with a system that includes multiple battery integrated load sources. In some such variations, power may be provided to each load source separately, wherein providing battery power to the load source can function individually for each load source. For example, a battery 1205 integrated with a single load source may provide supplementary power for function of that single load source.

Providing power to the external power usage can function to provide electrical power to a device connected to the local power grid. Providing power to the external power usage in various examples can provide sufficient power to the device to enable the device to function within device specifications. Some examples can provide power to multiple devices, and in some household energy grid implementations, can function in allocating power to dozens of devices/operations as necessary or desired.

Providing power to the external power usage may include providing power from the battery 1205 to the external power usage. Providing battery power to the external power usage may in some examples be dependent on the amount of external power usage and level of battery charge (e.g., current amount of power stored in the battery 1205). Providing battery power to the external power usage may allow for supplementary power for the external power usage when more power is being used, and the battery 1205 is sufficiently charged. Additionally, where the battery 1205 is incorporated with the load source, providing battery power to the external power usage in some examples can be reserved for times when the load source is not activated, and the battery 1205 is not providing (e.g., supplementary) power to the load source. Thus, providing battery power to the external power usage can function in various examples to provide supplementary power for general power usage on the local grid during times of increased power need and/or when the load source has reduced or no power need.

In some variations that include multiple batteries 1205 integrated with multiple load sources, each battery 1205 may have a separate call for providing battery power to the external power usage, wherein each non-activated load source may have its integrated battery 1205 provide power for external power usage, while each activated load source may have its integrated battery 1205 provide power for use of each activated load source.

Providing power to the battery 1205 can function to charge the battery 1205 from external power. Although providing power to the battery 1205 may occur in various examples any time the battery 1205 needs to be charged, in some examples charging the battery 1205 can be initiated in times of low power consumption of the local power grid, (e.g., during times that the load source is not in use and there is less than normal external power usage). For example, for a household power grid this may occur during the night.

In some embodiments, a load source can comprise a stove 130 with a load source system 1200 that operates on a standard 120V, 20-amp receptacle 1294, while still providing the functionality and quality of cooking experience available in a stove 130 that operates plugged into a standard 240V, 20-amp, 30-amp or 50-amp receptacle 1294. Various embodiments can comprise a stove 130 with a load source system 1200 that does not require electrical upgrades (e.g., installing a new 220V receptacle in place of a 110V receptacle) or skilled labor beyond that needed to perform a standard stove replacement, allowing the stove 130 to be installed in occupied apartments with limited resident disruption.

Various embodiments can include a stove 130 with a minimum of three cooking zones 132, at least two of which use induction coils; an electrically heated oven 140; be configured to plug into and operate from a standard three-prong household wall socket (e.g., 120VAC+/−10%, single phase, 60 Hz socket on a 20-amp circuit breaker); be configured for installation that does not require an electrician or other skilled labor and can be completed by property management staff within two hours; have a width of 24″ or 30″, and a form factor that matches a standard slide-in range; that will achieve relevant UL certifications and meet all other applicable, industry standard safety requirements; be a cost-effective electrification retrofit option for multifamily residential buildings; and the like.

In various embodiments, a load source (e.g., a stove 130) can be configured to pass one or more of the following standards: ASTM F1496: Standard Test Method for Performance of Convection Ovens; ASTM F1521: Standard Test Methods for Performance of Range Tops; UL 858: Standard for Household Electric Ranges; UL 2595: Standard for Safety for General requirements for battery-powered appliances; UL 1642: Standard for Lithium Batteries (Cells); UL 2054: Standard for Household and Commercial Batteries; UL/IEC 62133-2: Standard for Safety for Secondary Cells and Batteries containing Alkaline or Other Non-Acid Electrolytes—Safety Requirements for Portable Sealed Secondary Cells & for Batteries Made From Them for Use in Portable Application; UL 1973: Standard for Batteries for Use in Stationary, Vehicle Auxiliary Power and Light Electric Rail (LER) Applications; UL 9540A: Standard for Test Method for Evaluating Thermal Runaway Fire Propagation in Battery Energy Storage Systems; and the like.

Various embodiments can include a load source (e.g., a stove 130) having one or more of the following characteristics: maximum power of the load source running off an electrical panel that does not exceed 1,800 W; maximum Amps used by the load source while in use that does not exceed 16 A; a minimum of three cooking zones 132, with at least two of which comprising induction coils; one induction coil that is at least 8 inches in diameter and placed at the front of the range to facilitate its preferential use; a glass cooktop 144; being without exposed resistance coils for the cooking zones 132; the ability to combine two or more cooking zones into a larger single zone; have a water heat-up time on the cooking zones 132 of the cooktop 144 that is no more than 7 minutes (e.g., following ASTM F1521 Standard Test Methods for Performance of Range Tops); cooking zones 132 having a turndown ratio of at least 6:1 in at least 10 increments from lowest to highest heat (e.g., via knobs 1282 of an interface 1284); controls of a cooktop 144 and/or oven 140 that include a clock, timer, oven temperature display and oven/broiler presets (e.g., via an interface 1284); controls of an interface 1284 that are Americans with Disabilities Act (ADA) compliant; have a set of controls (e.g., knobs 1282) that are no higher than 48 inches above the ground and placed at the front of the stove 130 such that a user does not need to reach past or over a cooking zone 132 to control the cooking zone 132; an oven 140 with minimum volume of 2.5 cu ft for 24″ width or 4.5 cu ft for 30″ width; an oven 140 with a minimum of three rack positions; an oven 140 with a broiler; an oven 140 with a convection fan; an oven 140 with an oven light; an oven 140 with performance that meets or exceeds ASTM F1496; an oven 140 and/or broiler capable of operating at full power simultaneously with the largest heating zone 132 of the cooktop 144 at full power for at least 10 minutes; a battery 1205 integrated into the stove 130 such that the battery 1205 cannot be removed by a user, but that can be swapped out by a trained technician with the proper tools; a battery 1205 with a minimum of 5,000 charge cycles; and ability to operate two or more heating zones 132 of a cooktop at full power simultaneously with an oven 140 at full power for a minimum of ten minutes.

It should be clear that the embodiments discussed herein are only some example embodiments of a load source system 1200 and that load source systems 1200 having fewer or more elements or having more or less complexity are within the scope and spirit of the present disclosure. For example, one or more of the elements of FIG. 12-8 can be specifically absent in some embodiments, can be present in any suitable plurality, or the like. In some embodiments, a communication system 1350 can be absent and the load source system 1200 can be inoperable for wired and/or wireless communication with other devices. In some embodiments, elements such as processor 1310 and clock 1330 can be absent. The interface 1360 can comprise a plurality of interface elements or a complex interface in some examples or can be a simple interface 1360 in some embodiments or can be absent. In some embodiments, an interface for the load source system 1200 can be embodied on a separate device such as a user device (e.g., a smart phone, laptop, home automation system, or other suitable device). Additionally, battery systems 1200 can be various suitable sizes, including systems that weigh 1-5 pounds, 10-30 pounds, 50-100 pounds, 150-500 pounds, 500-1,500 pounds, or the like.

Additionally, in some embodiments, on-board or network control laws can be adaptive to patterns of use, which can allow a given battery capacity to adapt to expected demands. Further, these laws in various embodiments can be configured to adapt to local time-of-use rates, allowing behind-the-scenes energy arbitrage. Implementation of these control laws can be based on reinforcement learning and controls techniques, accompanied by best practice user interfaces allowing homeowner monitoring and tuning.

Various embodiments can be configured for managing the thermal requirements of the battery 1205 of the load source. Due to the high-energy density, thermal runaway of lithium batteries can be a safety concern and should be prevented in various examples. Additionally, on a less catastrophic level, operating batteries at elevated temperatures can impact lifetime of the battery. Because of these factors, a battery management system 1660 can have integrated temperature sensing and thermal interlocking. Accordingly, various embodiments can comprise a battery management system 1660 along with careful thermal design to isolate battery compartments from regions of the appliance or local environment with unsafe operating temperatures. For instance, an effective design strategy for thermal management in various embodiments is building high aspect ratio packs adjacent to the ambient environment. Another strategy can be to incorporate fire suppression at the appliance level in the individual load source system 1200. For example, in some embodiments a load source system 1200 can include a fire suppression system that comprises sensors operable to determine whether a fire is occurring in the battery, and if so, execute fire-suppression measures such as releasing foam, liquid, gas, generating a vacuum, or the like to extinguish the fire.

Some embodiments can be configured for obtaining adequate safety certifications by placing batteries directly into appliances and obtaining sufficient buy-in from appliance manufacturers to adopt this technology. Mitigation strategies may include one or more of the following. First, some embodiments can include data analytics and software modeling to estimate the most effective appliance targets and quantify value propositions. For instance, some examples can include localized estimates of the value per watt-hour capacity for each appliance based on time-of-use electricity prices, grid scale and distributed renewables enabled, and avoided electrical upgrade costs. Second, some embodiments can include hardware units which can sit between an existing appliance and the electrical outlet, before integrating with appliances. These hardware units can verify the value proposition in terms of achievable demand response under real-world use, as well as test robustness of the hardware, networking, and control electronics and can be used in place of appliances with integrated batteries, along with appliances with integrated batteries, with conventional appliances before replacement with a battery-integrated appliance, and the like. Third, various embodiments can include safety certifications through UL or another body, as well as green certifications through the nascent ENERGY STAR Connected Functionality program or similar.

In various embodiments (see, e.g., FIG. 12), the battery can reside within the appliance itself, whether a stove, refrigerator, HVAC system, clothes washer, clothes dryer, TV, game machines, tools, BBQ, lighting, lawnmower, grass blower, vacuum cleaner, blender, juicer, food processor, basement freezer, speakers, audio equipment, cooling fans, or other appliances. These batteries, in some examples, may be factory installed and integrated directly with the control electronics of the appliance.

In various embodiments, control schemes of such appliances may operate in several modes including one or more of the following examples. First, such appliances may effectively share loads between a wall plug and a battery based on estimated usage requirements without impeding user experience. This scheme may be used in some examples to maximize the energy used from a solar installation or other alternative energy source, or to enable the use of high-capacity devices running from a 110V socket or enable the use of time-of-use electricity rates. Another control scheme may operate when the appliance is not in use, nor expected to be in use in the near future, where the appliance provides energy arbitrage services, which can enable a house to absorb and store cheap electricity from the grid for later use.

In various embodiments, control schemes for battery integrated appliances may function using several levels of data including one or more of the following examples. First, they may rely only on calendar and time of day to predict loads and supply. Second, they may incorporate historical use data to tailor the algorithms to the habits of the user. Third, they may report data back to a central system where it is aggregated and used to provide control laws. Fourth, it may accept user input to switch control modes (for instance, a user can press a button to prepare the stove to cook a large meal, during which it will pre-charge to full capacity and/or load share between the battery and plug during operation). Fifth, they may use data about electricity rates (e.g., time-of-use rates) from the utility to tailor control laws to use the cheapest electricity from the grid. Sixth, they may use data from a rooftop solar array to predict and maximize the use of available solar electricity.

Additional benefits may be provided to the appliances by the batteries in accordance with further embodiments. For example, many conventional appliances have performance limited by the peak power provided by the wall outlet. The batteries can allow for much higher peak powers, which can be used to increase the performance of appliances. For instance, induction stoves can have extremely fast temperature ramp up, higher peak outputs, and lower noise. On-demand water heating can have higher capacity, enabling storage-free water heaters with higher outputs. Electric kettles can be made to boil faster. For devices with motors, these motors can be run with higher peak powers, and if desired, at voltages more optimal than the AC from the wall. In some cases, the battery thermal management can be synergistic with the appliance performance. For instance, the heat from the battery pack can boost the coefficient of performance of heat pump devices like electric dryers.

With a home electric system, many costs can be proportional to peak power. Installing batteries at end uses can decrease peak power, and hence decrease these costs. By enabling hybrid AC/DC systems, battery-integrated appliances may also enable the use of higher efficiency solid state power conversion, including inverters and DC/DC voltage conversion.

Battery-integrated appliances of various embodiments can provide fire retardant capabilities, to protect against thermal runaway of lithium batteries, and can include a fire alarm to warn of an emergency. Device health monitoring may also be incorporated to monitor the state of health of the battery pack. This can be implemented through capacity monitoring, internal resistance measurements, or impedance spectroscopy. Such devices may also be made waterproof to protect batteries and electronics. These devices can also provide voltage regulation services for the house electrical system.

In various embodiments, a battery can allow high-power appliances to be usable with 120V receptacles as opposed to having to install a 240V power source. In some examples, batteries can have 4-24 hours of storage. Some embodiments can obtain real-time or historical use data for a room, house, building, block, city, state, and the like. In various examples, it can be beneficial to minimize inversions (e.g., inverter in battery module that sits on DC bus can prevent multiple inversions). Some embodiments can have power sharing between appliances (e.g., via extension cords, existing or new in-wall wiring, Ethernet, and the like). Some examples can have a battery module that is integral or replaceable within the appliance. Such a battery module can be configured to be a self-contained unit that is waterproof, heatproof, and the like, and can provide for shallow cycling of battery, fire suppression, battery monitoring, and the like. The whole module, including control systems, may be a replaceable unit since control systems may be inexpensive compared to the battery.

The battery module in various examples can obtain and use different types of data to control battery use. This can depend on network connectivity or complexity of the system. A simple battery module can simply include a clock and lookup table with the battery module operating based on time, day, season, or the like. Another more complex version can store use history from only the battery module itself or local battery modules and use a clock to control battery operation. Another more complex version can have network connectivity (e.g., to the Internet), which can provide access to data from an electrical grid, use data from remote modules, etc.

Various embodiments can be configured to forecast use based on data discussed above, or the like. Some embodiments can be configured to operate based on user input (e.g., user indicates he is about to or will cook a meal at a later time or date). Forecasting can be based on data such as user calendars, user defined schedules, or the like.

Some devices can have large ramp-up requirements and having a local battery 1205 can reduce this, resulting in faster, better appliances (e.g., faster heating). Appliances can be configured to dial up voltages as necessary to provide for improved appliances. Other benefits can include electrostatics in washer/dryer, quieter operation from supersonic induction, increased efficiency of inverters, and the like.

While specific examples are discussed herein, these examples should not be construed to be limiting on the wide variety of alternative and additional embodiments that are within the scope and spirit of the present disclosure. For example, appliances, devices or systems can be associated with one or more batteries as discussed herein. Also, while residential examples are the focus of some examples herein, further embodiments can include multi-family buildings, commercial buildings, vehicles, or the like.

As used herein, first, second, third, etc., are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, elements that are specifically shown in example embodiments should be construed to cover embodiments that comprise, consist essentially of, or consist of such elements, or such elements can be explicitly absent from further embodiments. Accordingly, the recitation of an element being present in one example should be construed to support some embodiments where such an element is explicitly absent.

What is claimed is:

1. A method of controlling heating of a cooking vessel on an inductive stove, the method comprising:
placing a shield coil assembly on a cooktop of an induction stove over an induction coil of the induction stove, the shield coil assembly comprising:
a shield coil,
a switching element configured to switch the shield coil between a transparent mode and a shielded mode, wherein switching between the transparent mode and the shielded mode is configured to generate dynamic control of coupling efficiency between the induction coil of the induction stove and an object placed on the shield coil assembly,
a microcontroller configured to execute program instructions for controlling one or more operations of the shield coil assembly based on instructions stored in a memory, the one or more operations including the switching between the transparent mode and the shielded mode,
control circuitry configured to coordinate the one or more operations including the switching between the transparent mode and the shielded mode,
a temperature sensor,
an interface configured for a user to input at least one of a user-defined temperature or a user-defined temperature range, and
a communication module configured to communicate wirelessly with at least one of the induction stove, a user device or a remote server;
placing the cooking vessel on the shield coil assembly on the cooktop of the induction stove over the induction coil the induction stove;
switching, by the microcontroller controlling the switching element, the shield coil assembly to the transparent mode to allow inductive heating of the cooking vessel,
obtaining first state data, that includes first temperature data obtained from the temperature sensor;
determining to switch to the shielded mode based at least in part on the obtained first state data including the first temperature data obtained from the temperature sensor, and in response, switching, by the microcontroller controlling the switching element, the shield coil assembly to the shielded mode from the transparent mode, to prevent or reduce inductive heating compared to the transparent mode;
obtaining second state data, that includes second temperature data obtained from the temperature sensor; and
determining to switch to the transparent mode based at least in part on the obtained second state data, and in response, switching, by the microcontroller controlling the switching element, the shield coil assembly to the transparent mode from the shielded mode to allow inductive heating of the cooking vessel,
wherein the switching between the shielded mode and the transparent mode causes the shield coil assembly, based at least on monitoring temperature of the cooking vessel via the temperature sensor, to heat the cooking vessel on the shield coil assembly to the user-defined temperature or the user-defined temperature range and holding the cooking vessel at the user-defined temperature or within the user-defined temperature range.

2. The method of claim 1, wherein the switching element comprises a Metal-Oxide-Semiconductor Field-Effect Transistor (MOSFET) switching element.

3. The method of claim 1, wherein determining to switch between the shielded mode and the transparent mode is further based on time data in addition to temperature data generated by the shield coil assembly, including causing the shield coil assembly to heat the cooking vessel to the user-defined temperature or the user-defined temperature range and can then be held at the user-defined temperature or the user-defined temperature range for a defined period of time and then switching to the shielded mode to cease heating of the cooking vessel.

4. The method of claim 1, wherein the shield coil assembly further comprises:
a transformer,
a rectifier, and
a regulator.

5. The method of claim 1, wherein the shield coil assembly defines a planar circular body with a tab extending from a side of the circular planar body coincident a plane of the planar circular body, with the planar circular body having:
a thickness of between, 0.4 cm and 0.8 cm, and
a diameter between 6.0 inches and 10.0 inches.

6. A method of controlling heating of a cooking vessel on an inductive stove, the method comprising:
placing a shield coil assembly on a cooktop of an induction stove over an induction coil of the induction stove, the shield coil assembly comprising:
a shield coil,
a switching element configured to switch the shield coil between a transparent mode and a shielded mode,
a microcontroller,
a temperature sensor,
an interface configured for a user to input at least one of a user-defined temperature or a user-defined temperature range, and
placing the cooking vessel on the shield coil assembly on the cooktop of the induction stove over the induction coil the induction stove;
obtaining first state data, that includes first temperature data obtained from the temperature sensor;
determining to switch to the shielded mode based at least in part on the obtained first state data including the first temperature data obtained from the temperature sensor, and in response, switching, by the microcontroller controlling the switching element, the shield coil assembly to the shielded mode from the transparent mode, to prevent or reduce inductive heating compared to the transparent mode;
obtaining second state data, that includes second temperature data obtained from the temperature sensor; and
determining to switch to the transparent mode based at least in part on the obtained second state data, and in response, switching, by the microcontroller controlling the switching element, the shield coil assembly to the transparent mode from the shielded mode to allow inductive heating of the cooking vessel.

7. The method of claim 6, wherein switching between the transparent mode and the shielded mode is configured to generate dynamic control of coupling efficiency between the induction coil of the induction stove and the cooking vessel placed on the shield coil assembly.

8. The method of claim 6, wherein the microcontroller configured to execute program instructions for controlling one or more operations of the shield coil assembly based on instructions stored in a memory, the one or more operations including the switching between the transparent mode and the shielded mode.

9. The method of claim 6, wherein the switching between the shielded mode and the transparent mode causes the shield coil assembly, based at least on monitoring temperature of the cooking vessel via the temperature sensor, to heat the cooking vessel on the shield coil assembly to the user-defined temperature or the user-defined temperature range and holding the cooking vessel at the user-defined temperature or within the user-defined temperature range.

10. The method of claim 6, wherein the shield coil assembly further comprises a communication module configured to communicate wirelessly with at least one of the induction stove, a user device or a remote server.

11. A method of controlling heating of a vessel on an inductive stove, the method comprising:
placing a shield coil assembly over an induction coil of the induction stove, the shield coil assembly comprising:
a shield coil, and
a switching element configured to switch the shield coil between a transparent mode and a shielded mode;
obtaining first state data;
determining to switch to the shielded mode based at least in part on the obtained first state data, and in response, switching the shield coil assembly to the shielded mode from the transparent mode, to prevent or reduce inductive heating compared to the transparent mode;
obtaining second state data; and
determining to switch to the transparent mode based at least in part on the obtained second state data, and in response, switching the shield coil assembly to the transparent mode from the shielded mode to allow inductive heating of the vessel.

12. The method of claim 11, wherein the shield coil assembly further comprises a microcontroller.

13. The method of claim 12, wherein the microcontroller is configured to control a switching element to switch the shield coil assembly to the shielded mode, and
wherein the microcontroller is configured to control the switching element to switch the shield coil assembly to the transparent mode.

14. The method of claim 11, wherein the shield coil assembly further comprises a temperature sensor.

15. The method of claim 14, wherein the first state data and the second state data comprise temperature data obtained from the temperature sensor.

16. The method of claim 11, wherein the shield coil assembly further comprises an interface configured for a user to input at least one of a user-defined temperature or a user-defined temperature range.

17. The method of claim 11, wherein the vessel is a cooking vessel.

18. The method of claim 11, further comprising placing the shield coil assembly on a cooktop of the induction stove over the induction coil of the induction stove.

19. The method of claim 11, further comprising placing the vessel on the shield coil assembly on the induction stove over the induction coil the induction stove.
